(19) United States
(12) Patent Application Publication
(10) Pub. No.: US 2022/0197721 A1
(43) Pub. Date: Jun. 23, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Ryuichi HORIGANE, Kanagawa (JP)

(73) Assignee: FUJIFILM Business Innovation Corp., Tokyo (JP)

(21) Appl. No.: 17/338,686

(22) Filed: Jun. 4, 2021

(30) Foreign Application Priority Data
Dec. 22, 2020 (JP) 2020-212637

(51) Int. Cl. G06F 9/54; G06F 3/0484; G06F 9/445

(52) U.S. Cl. CPC G06F 9/541; G06F 3/0482; G06F 9/44526; G06F 3/0484

(57) ABSTRACT

An information processing apparatus includes a processor configured to output information on first software, and output information on second software executing a process to be performed before or after a process executed by the first software, in a form associated with the information on the first software.

### CROSS-REFERENCE TO RELATED APPLICATIONS

This application is based on and claims priority under 35 USC 119 from Japanese Patent Application No. 2020-212637 filed Dec. 22, 2020.

### BACKGROUND

### (i) Technical Field

The present invention relates to an information processing apparatus and a non-transitory computer readable medium storing a program.

### (ii) Related Art

JP2014-32687A discloses that in an integrated management device, a cooperation software component including setting information and an expansion program for function cooperation is acquired from software implementing a function, and that a difference in operation environment of a program interface is accommodated based on an analysis result of the acquired cooperation software component.

In JP2008-305004A, an image forming apparatus in which an application is constructed by a combination of software components each executing input and output of image data or image processing on image data, and that includes a cooperator consecutively executing a plurality of applications is disclosed.

### SUMMARY

In a case of processing data using first software in a specific task, the data may not be processed by only the first software, or the specific task may not be completed by only processing of the first software. In order to process the data or complete the specific task, second software different from the first software is additionally needed. However, a user who knows presence of the first software may not perceive presence of the second software.

Aspects of non-limiting embodiments of the present disclosure relate to an information processing apparatus and a non-transitory computer readable medium storing a program that enable a user to perceive information on second software, compared to a case of not outputting the information on the second software executing a process which is to be executed before or after a process executed by first software.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to output information on first software, and output information on second software executing a process to be performed before or after a process executed by the first software, in a form associated with the information on the first software.

### BRIEF DESCRIPTION OF THE DRAWINGS

Exemplary embodiment(s) of the present invention will be described in detail based on the following figures, wherein:

FIG. 1 is a diagram showing an overall configuration example of a notification system according to the present exemplary embodiment;

FIG. 2 is a diagram showing a hardware configuration of a management server and a user terminal;

FIG. 3 is a block diagram showing a functional configuration example of the management server;

FIG. 4 is a diagram showing a configuration of a plug-in;

FIG. 5 is a diagram showing a plug-in information management table;

FIG. 6 is a flowchart showing a flow of information output process;

FIG. 7 is a diagram showing a plug-in designation screen;

FIG. 8 is a diagram showing a plug-in screen;

FIG. 9 is a diagram showing a plug-in information portion;

FIG. 10 is a diagram showing the plug-in information portion;

FIGS. 11A to 11D are diagrams showing a result screen;

FIG. 12 is a diagram showing a plug-in information management table as a modification example;

FIG. 13 is a flowchart showing a flow of information output process as a modification example;

FIGS. 14A and 14B are diagrams showing the plug-in information portion;

FIG. 15 is a diagram showing a modification example of the plug-in information portion of “high resolution” in FIG. 10;

FIG. 16 is a diagram showing a management screen;

FIGS. 17A and 17B are diagrams showing a toolbar in a modification example;

FIGS. 18A to 18C are diagrams showing the toolbar in a modification example;

FIG. 19 is a flowchart showing a flow of information output process in a modification example;

FIG. 20A is a diagram showing a file selection screen, and FIG. 20B is a diagram showing an execution prompt screen;

FIG. 21 is a diagram showing a method notification screen;

FIG. 22A is a diagram showing the management screen, and FIG. 22B is a diagram showing a content notification screen; and

FIG. 23A is a diagram showing a setting screen, and FIG. 23B is a diagram showing the management screen.

### DETAILED DESCRIPTION

Hereinafter, an exemplary embodiment of the present invention will be described in detail with reference to the accompanying drawings.

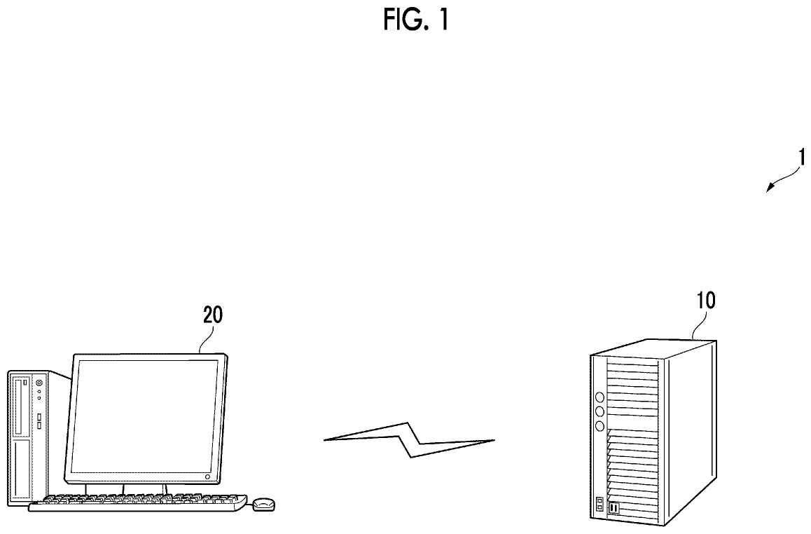

FIG. 1 is a diagram showing an overall configuration example of a notification system 1 according to the present exemplary embodiment. The notification system 1 of the present exemplary embodiment is a system that performs notification of information on a plug-in. More specifically, the notification system 1 performs notification of information on a specific plug-in and information on a plug-in that processes a form of data for which a process of the specific plug-in is not available, to a form of data for which the process of the specific plug-in is available. A plug-in is software including a program that adds a function to software. Hereinafter, the plug-in that processes the form of the data for which the process of the plug-in is not available, to the form of the data for which the process of the plug-in is available will be referred to as an enabler plug-in.

The notification system 1 includes a management server 10 and a user terminal 20. The management server 10 and the user terminal 20 are connected through a network.

The management server 10 as an example of an information processing apparatus is a server that provides plug-ins. In addition, the management server 10 outputs information on a plug-in designated by a user among a plurality of plug-ins. Furthermore, the management server 10 outputs information on the enabler plug-in in a case where a plug-in having a relationship of the enabler plug-in with the plug-in designated by the user is present.

For example, the management server 10 is implemented by a computer. The management server 10 may be configured with a single computer or may be implemented by distributed processing using a plurality of computers.

The user terminal 20 is a terminal used by the user who uses the notification system 1. In a case where the user terminal 20 receives a designation of any plug-in among the plurality of plug-ins from the user, the user terminal 20 notifies the management server 10 of a received content. In addition, in a case where the user terminal 20 acquires the information on the plug-in designated by the user from the management server 10, the user terminal 20 displays the acquired information. Furthermore, the user terminal 20 downloads the plug-in managed by the management server 10 in response to an instruction from the user. The user views the information on the plug-in displayed on the user terminal 20 and then, causes the user terminal 20 to download the plug-in that is determined as necessary.

For example, a computer, a smartphone, a tablet information terminal, or other information processing apparatuses are exemplified as the user terminal 20.

A type of network connecting the management server 10 to the user terminal 20 is not particularly limited as long as transmission and reception of data are available. A communication line used for transmitting and receiving data may be wired or wireless.

In addition, while one management server 10 and one user terminal 20 are shown in the example shown in FIG. 1, the number of management servers 10 or user terminals 20 is not limited to one as shown. Two or more management servers 10 may be disposed in the notification system 1. In addition, two or more user terminals 20 may be disposed in the notification system 1.

Hardware Configuration

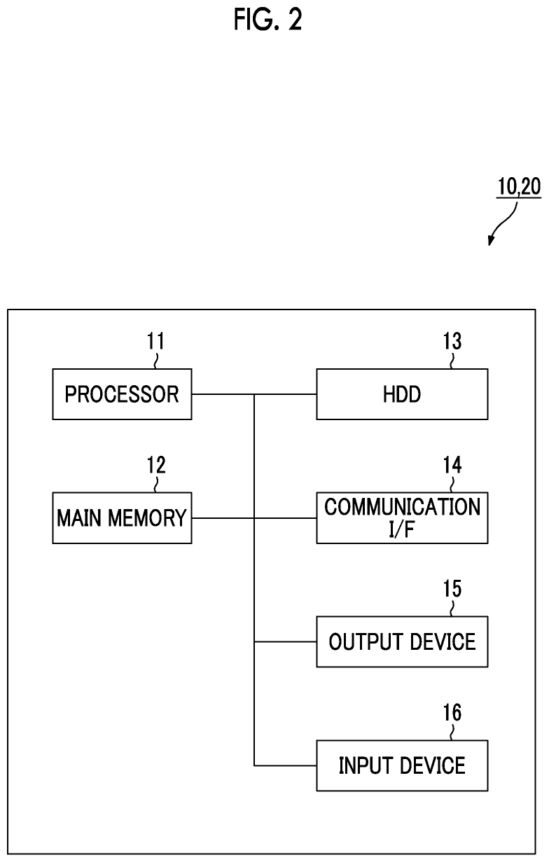

Next, a hardware configuration of the management server 10 and the user terminal 20 will be described. FIG. 2 is a diagram showing the hardware configuration of the management server 10 and the user terminal 20. In the following description, the management server 10 and the user terminal 20 will be referred to as the “management server 10 or the like” in a case where no particular distinction is made therebetween.

The management server 10 or the like includes a processor 11, a main memory 12, and a hard disk drive (HDD) 13. In addition, the management server 10 or the like includes a communication I/F 14 for external communication, an output device 15 that outputs information, and an input device 16 such as a keyboard or a mouse.

The processor 11 implements various functions, described later, by executing various types of software such as an operating system (OS) and applications.

The main memory 12 stores the various types of software, data used for executing the various types of software, and the like. The main memory 12 includes a ROM that stores a basic input output system (BIOS) or the like, and a RAM that is used as a work area. The ROM and the RAM may be included in a part of the processor 11.

The HDD 13 stores input data for the various types of software and output data from the various types of software.

For example, a liquid crystal display or an electro luminescence (EL) display is exemplified as the output device 15.

The output device 15 and the input device 16 may be configured as a touch panel display that receives an input by a contact operation performed on a display surface displaying images. In addition, the output device 15 may include a speaker that outputs sound.

Document Handling Software

Next, document handling software used in the user terminal 20 will be described.

The document handling software of the present exemplary embodiment digitizes a paper document read by a scanner or the like and manages the digitized paper document as a document file. A document file is a file indicating a document. In addition, a file is a collection of information such as a document or an image. In addition, even a document file that is created using application software different from the document handling software is created and managed as one document file by the document handling software of the present exemplary embodiment.

In a case where the document file of a management target is a document file created by a specific type of application software, the document handling software may manage the document file by converting a format of the document file. For example, a document file that is created by application software different from the document handling software and is a document file in a format unique to the application software is exemplified as the document file created by the specific type of application software. Hereinafter, the document file that is created by the application software different from the document handling software and is the document file in the format unique to the application software will be referred to as an application file. In addition, hereinafter, the document file of which the format is converted from the application file by the document handling software will be referred to as an app document.

In addition, in a case where the document file of the management target is a document file in an image data format, the document handling software may manage the document file by converting the format of the document file to a format different from the app document. For example, a bitmap, a tagged image file format (TIFF), or a joint photographic experts group (JPEG) is exemplified as the image data format. In addition, hereinafter, the document file of which the format is converted from the image data format by the document handling software will be referred to as an image document.

The document handling software creates and manages the app document or the image document in accordance with the format of the document file of the management target.

In addition, a function of the document handling software is added by downloading the plug-in to the user terminal 20. That is, drawing a marker, putting a stamp, and the like in the document file are available by the processor 11 of the user terminal 20 using the plug-in downloaded to the user terminal 20. The plug-in downloaded to the user terminal 20 is stored in the main memory 12.

The user terminal 20 of the present exemplary embodiment displays a predetermined image on the liquid crystal display, which is an example of the output device 15, based on the document handling software. Display of the image in the user terminal 20 is implemented by the processor 11, the main memory 12, and the HDD 13 of the user terminal 20 and the processor 11, the main memory 12, and the HDD 13 of the management server 10 connected to the user terminal 20 through the network. In addition, the user terminal 20 receives an operation of the user for the image displayed based on the document handling software. Reception of the operation for the displayed image by the user terminal 20 is performed by the keyboard or the mouse which is an example of the input device 16.

Functional Configuration of Management Server

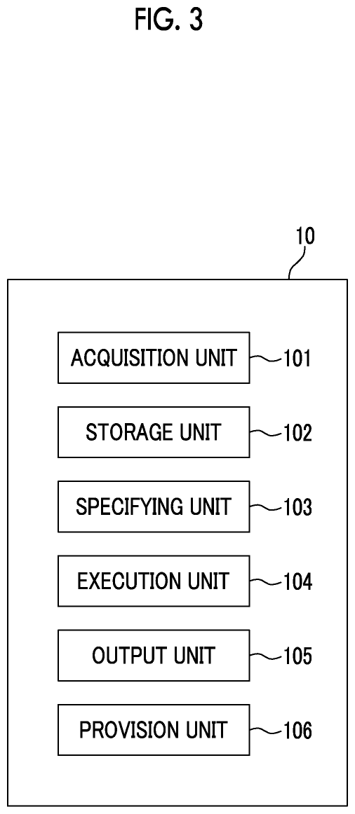

Next, a functional configuration of the management server 10 will be described. FIG. 3 is a block diagram showing a functional configuration example of the management server 10.

In FIG. 3, a part of functions implemented by the processor 11 through execution of an application program is shown.

The management server 10 includes an acquisition unit 101, a storage unit 102, a specifying unit 103, an execution unit 104, an output unit 105, and a provision unit 106.

The acquisition unit 101 acquires information from the user terminal 20. More specifically, the acquisition unit 101 acquires, from the user terminal 20, information indicating which plug-in is designated by the user among the plurality of plug-ins in the user terminal 20, and information indicating that execution of a process of the plug-in is requested by the user. In addition, the acquisition unit 101 acquires, from the user terminal 20, information indicating that download of the plug-in is requested by the user in the user terminal 20. In a case where the acquisition unit 101 acquires the information indicating whether or not any plug-in is designated, the acquisition unit 101 transmits the acquired information to the specifying unit 103. In addition, in a case where the acquisition unit 101 acquires the information indicating that execution of the process of the plug-in is requested, the acquisition unit 101 transmits the acquired information to the execution unit 104. In addition, in a case where the acquisition unit 101 acquires the information indicating that download of the plug-in is requested, the acquisition unit 101 transmits the acquired information to the provision unit 106.

The storage unit 102 stores the plug-in, the information on the plug-in, and the like. A storage content of the storage unit 102 will be described in detail later.

In a case where the specifying unit 103 acquires the information from the acquisition unit 101, the specifying unit 103 specifies which plug-in is designated by the user among the plurality of plug-ins from the acquired information. Hereinafter, the plug-in designated by the user will be referred to as a designated plug-in. The specifying unit 103 extracts information on the specified designated plug-in from the storage unit 102 and transmits the extracted information to the output unit 105.

In addition, in a case where data for which a process of the designated plug-in is not available is determined, the specifying unit 103 of the present exemplary embodiment specifies a plug-in having the relationship of the enabler plug-in with the designated plug-in. The specifying unit 103 extracts information on the specified enabler plug-in from the storage unit 102 and transmits the extracted information to the output unit 105.

The execution unit 104 executes processing by the plug-in. In a case where the execution unit 104 acquires the information from the acquisition unit 101, the execution unit 104 specifies whether or not the user requests execution of the process of any plug-in from the acquired information. The process of the specified plug-in is executed on predetermined data, and a result of the executed process is transmitted to the output unit 105.

The output unit 105 outputs the information acquired from the specifying unit 103 and the execution unit 104 to the user terminal 20.

The provision unit 106 provides the plug-in to the user terminal 20. In a case where the provision unit 106 acquires the information from the acquisition unit 101, the provision unit 106 specifies whether or not download of any plug-in is requested from the acquired information. The specified plug-in is extracted from the storage unit 102, and the extracted plug-in is provided to the user terminal 20. Accordingly, the plug-in requested by the user is downloaded to the user terminal 20.

Download of the plug-in by the user terminal 20 may be implemented as free download or may be implemented as paid download.

Configuration of Plug-In

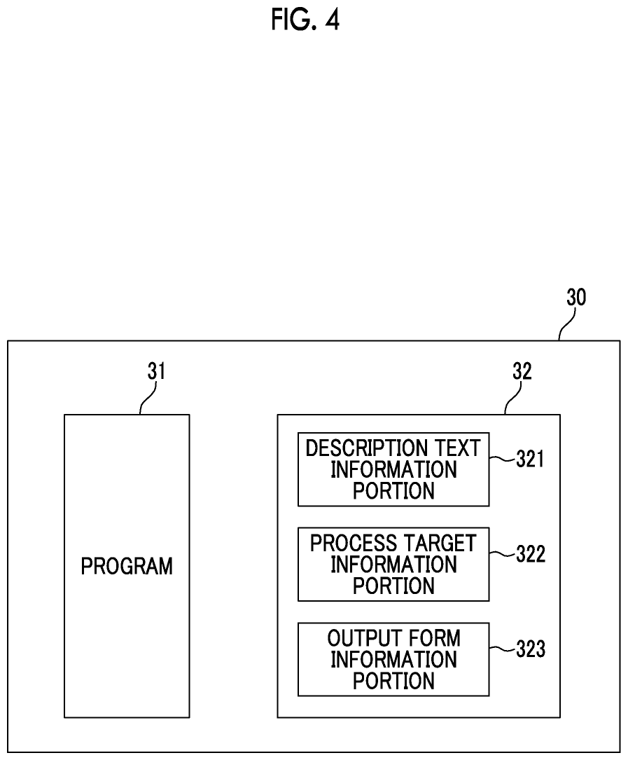

Next, a configuration of the plug-in of the present exemplary embodiment will be described. FIG. 4 is a diagram showing the configuration of the plug-in.

A plug-in 30 as an example of software includes a program 31 and a process information portion 32.

The program 31 is a program that is executed by the processor 11 of the management server 10 or the like.

Information related to a process executed using the plug-in 30 is included in the process information portion 32. The process information portion 32 includes a description text information portion 321, a process target information portion 322, and an output form information portion 323.

Information on a sentence describing the process executed using the plug-in 30 is included in the description text information portion 321.

Information on a target of the process using the plug-in 30 is included in the process target information portion 322. For example, a form of data that is the target of the process using the plug-in 30 is exemplified as the target of the process using the plug-in 30. In addition, for example, a size of a file, a resolution of an image included in the file, or a format of the file is exemplified as the form of the data.

Information on a form of data that is output by executing the process using the plug-in 30 is included in the output form information portion 323.

Storage Content of Storage Unit

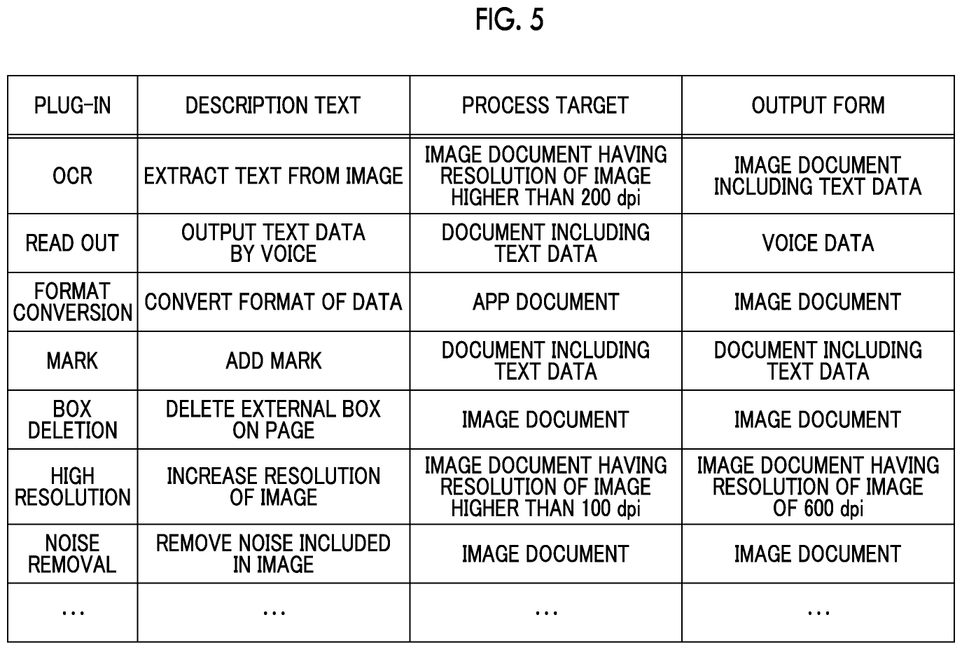

Next, a content of information stored in the storage unit 102 will be described. FIG. 5 is a diagram showing a plug-in information management table. The plug-in information management table is a table for managing information on the plug-in 30. The plug-in information management table is stored in the storage unit 102.

In the plug-in information management table, a name of the plug-in 30 is shown in “plug-in”.

In addition, in the plug-in information management table, the sentence describing the process executed using the plug-in 30 is shown in “description text”. Information shown in “description text” is the information included in the description text information portion 321 of the plug-in 30.

In addition, in the plug-in information management table, information on a target for which the process using the plug-in 30 is available is shown in “process target”. The information shown in “process target” is the information included in the process target information portion 322 of the plug-in 30.

In addition, in the plug-in information management table, information on the form of the data output by executing the process using the plug-in 30 is shown in “output form”. The information shown in “output form” is the information included in the output form information portion 323 of the plug-in 30.

Information shown in the plug-in information management table will be described with a specific example.

First, information on the plug-in 30 of “OCR” will be described. Here, “extract text from image” is shown in “description text” of “OCR”.

In addition, “image document having resolution of image higher than 200 dpi” is shown in “process target” of “OCR”. This means that in a case where the data of the target of the process is the app document or the image document having a resolution of the image lower than or equal to 200 dpi, the process of the data using the plug-in 30 of “OCR” is not available.

In addition, “image document including text data” is shown in “output form” of “OCR”. This means that in a case where the process using the plug-in 30 of “OCR” is executed on the data, an image document including text data is output.

Next, information on the plug-in 30 of “format conversion” will be described. Here, “convert format of data” is shown in “description text” of “format conversion”.

In addition, “app document” is shown in “process target” of “format conversion”.

In addition, “image document” is shown in “output form” of “format conversion”.

Next, information on the plug-in 30 of “high resolution” will be described. Here, “increase resolution of image” is shown in “description text” of “high resolution”.

In addition, “image document having resolution of image higher than 100 dpi” is shown in “process target” of “high resolution”.

In addition, “image document having resolution of image of 600 dpi” is shown in “output form” of “high resolution”.

Here, “app document” shown in “process target” of “format conversion” is data of a form that is not “process target” of “OCR”. In addition, “image document” shown in “output form” of “format conversion” is data of a form included in “process target” of “OCR”. Thus, the plug-in 30 of “format conversion” is the plug-in 30 that changes the form of the data for which the process of the plug-in 30 of “OCR” is not available, to the form of the data for which the process of the plug-in 30 of “OCR” is available. In other words, the plug-in 30 of “format conversion” has the relationship of the enabler plug-in with the plug-in 30 of “OCR”.

In addition, “image document having resolution of image higher than 100 dpi” shown in “process target” of “high resolution” includes the data of the form that is not “process target” of “OCR”. In addition, “image document having resolution of image of 600 dpi” shown in “output form” of “high resolution” is the data of the form included in “process target” of “OCR”. Thus, the plug-in 30 of “high resolution” has the relationship of the enabler plug-in with the plug-in 30 of “OCR”.

That is, the enabler plug-in is the plug-in 30 having “process target” associated with data of a form that is not “process target” of the designated plug-in, and having “output form” associated with data of a form that is “process target” of the designated plug-in. In other words, the enabler plug-in of the present exemplary embodiment is determined from a relationship between data processed by one plug-in 30 of two plug-ins 30 and the process of the other plug-in 30 performed on the processed data.

Information Output Process

Next, a flow of information output process will be described. The information output process is a process of outputting the information on the plug-in 30. The information output process is performed by the processor 11 of the management server 10.

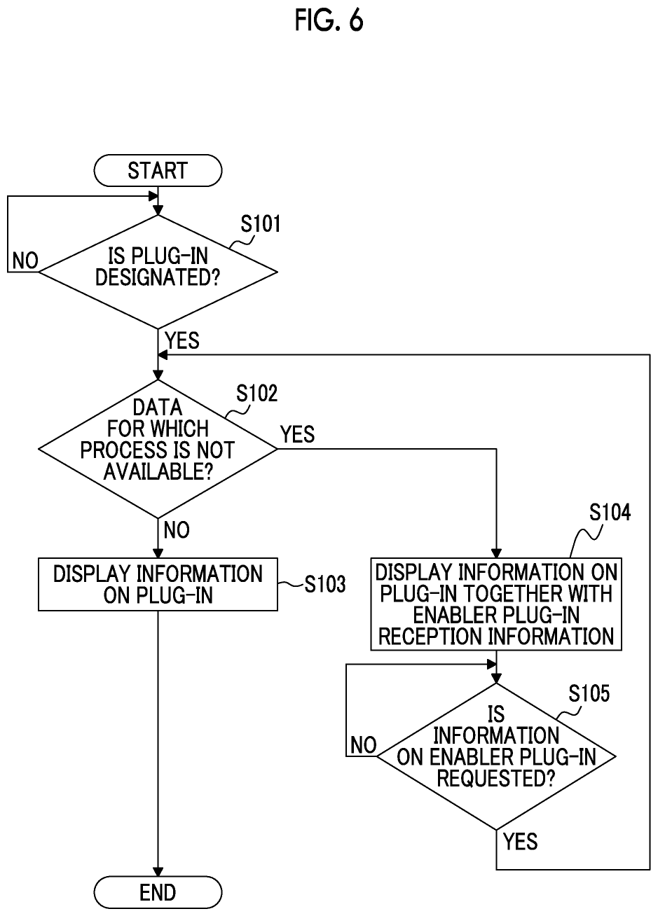

FIG. 6 is a flowchart showing the flow of information output process.

The acquisition unit 101 of the management server 10 determines whether or not any plug-in 30 among a plurality of plug-ins 30 is designated by the user in the user terminal 20 (step (hereinafter, referred to as S) S101). The acquisition unit 101 performs the determination based on whether or not information indicating whether or not any plug-in 30 is designated by the user in the user terminal 20 is acquired. In addition, while a negative result continues, the acquisition unit 101 repeats a process of step S101.

Meanwhile, in a case where the information indicating whether or not any plug-in 30 is designated by the user is acquired by the acquisition unit 101 (YES in S101), the specifying unit 103 determines whether or not data for which the process of the designated plug-in is not available is determined (S102). The specifying unit 103 refers to the plug-in information management table (refer to FIG. 5) stored in the storage unit 102. The determination is performed based on whether or not the plug-in 30 having “process target” associated with the data of the form that is not “process target” of the designated plug-in, and having “output form” associated with the data of the form that is “process target” of the designated plug-in is present. In other words, the specifying unit 103 determines whether or not the data for which the process of the designated plug-in is not available is determined, based on whether or not the plug-in 30 having the relationship of the enabler plug-in with the designated plug-in is present.

In a case where the specifying unit 103 determines that the data for which the process of the designated plug-in is not available is not determined (NO in S102), the specifying unit 103 extracts the information on the designated plug-in from the storage unit 102 and transmits the extracted information to the output unit 105. The output unit 105 displays the acquired information on the designated plug-in on the user terminal 20 (S103).

In addition, in a case where the specifying unit 103 determines that the data for which the process of the designated plug-in is not available is determined (YES in S102), the specifying unit 103 transmits the information on the designated plug-in and enabler plug-in reception information to the output unit 105. The enabler plug-in reception information is information on a form in which a request for the information on the enabler plug-in from the user is receivable. The output unit 105 displays the acquired information on the designated plug-in and the enabler plug-in reception information on the user terminal 20 (S104).

The acquisition unit 101 determines whether or not the request for the information on the enabler plug-in from the user is acquired (S105). The acquisition unit 101 performs the determination based on whether or not information indicating that the information on the enabler plug-in is requested by the user is acquired from the user terminal 20. While a negative result continues, the acquisition unit 101 repeats a process of step S105.

Meanwhile, in a case where the acquisition unit 101 acquires the request for the information on the enabler plug-in (YES in S105), a process from step S102 is performed by targeting the requested enabler plug-in. That is, in a case where the specifying unit 103 determines that data for which the process of the requested enabler plug-in is not available is determined (YES in S102), the specifying unit 103 displays the information on the enabler plug-in and plug-in reception information on the plug-in 30 having the relationship of the enabler plug-in with the enabler plug-in (S104). In addition, in a case where the specifying unit 103 determines that the data for which the process of the requested enabler plug-in is not available is not determined (NO in S102), the specifying unit 103 displays the information on the requested enabler plug-in (S103).

In the present exemplary embodiment, while the specifying unit 103 determines whether or not the data for which the process of the designated plug-in is not available is determined, by referring to the information management table (refer to FIG. 5), the invention is not limited thereto. The specifying unit 103 may determine whether or not the data for which the process of the designated plug-in is not available is determined, by referring to the process target information portion 322 and the output form information portion 323 included in the process information portion 32 of the plug-in 30.

Display Screen

Next, images displayed on the user terminal 20 in the information output process will be described.

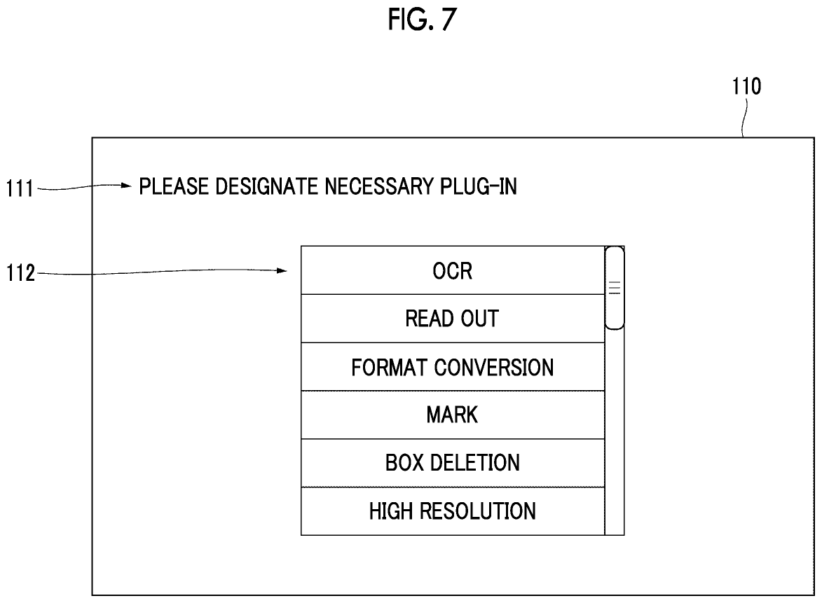

FIG. 7 is a diagram showing a plug-in designation screen 110. The plug-in designation screen 110 is a screen for causing the user to designate any plug-in among the plurality of plug-ins. The plug-in designation screen 110 is displayed on the user terminal 20.

A designation prompt portion 111 and a plug-in list portion 112 are displayed on the plug-in designation screen 110.

Information for prompting the user to designate the plug-in is shown in the designation prompt portion 111. In the shown example, a text “please designate necessary plug-in” is displayed in the designation prompt portion 111.

A list of plug-ins 30 is shown in the plug-in list portion 112.

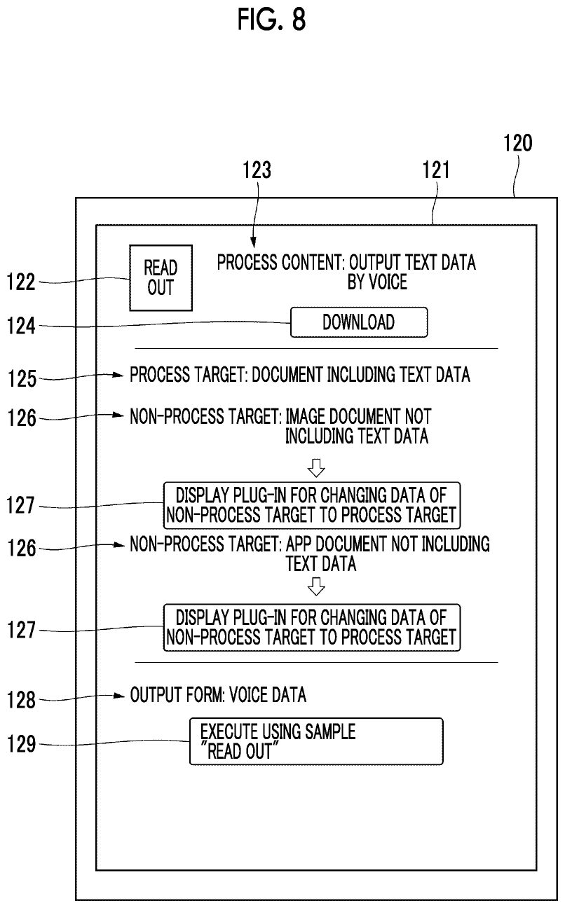

Here, for example, in a case where the user designates “read out” in the plug-in list portion 112, a plug-in screen 120 is displayed as shown in FIG. 8. The plug-in screen 120 is a screen on which the information on the plug-in is shown. In addition, a plug-in information portion 121 is displayed on the plug-in screen 120. Information on one plug-in 30 is shown in the plug-in information portion 121. The plug-in information portion 121 shown in FIG. 8 is the plug-in information portion 121 related to “read out” that is the designated plug-in.

An icon portion 122, a content information portion 123, a download reception portion 124, a target information portion 125, a non-target information portion 126, an enabler plug-in reception portion 127, an output information portion 128, and an execution reception portion 129 are displayed in the plug-in information portion 121.

An icon of the plug-in 30 is shown in the icon portion 122. In the shown example, an icon of “read out” that is the designated plug-in is shown in the icon portion 122.

A content of the process executed by the plug-in 30 is shown in the content information portion 123. The content information portion 123 of the present exemplary embodiment includes information shown in “description text” of the plug-in information management table (refer to FIG. 5). In the shown example, a text “process content: output text data by voice” is shown in the content information portion 123.

The download reception portion 124 is used for receiving download of the plug-in 30. In a case where the download reception portion 124 is selected by the user, the provision unit 106 of the management server 10 provides one plug-in 30 that is a target in the plug-in information portion 121 to the user terminal 20. Accordingly, the plug-in 30 is downloaded to the user terminal 20.

Information on the form of the data that is the target of the process of the plug-in 30 is shown in the target information portion 125. The target information portion 125 of the present exemplary embodiment includes information shown in “process target” of the plug-in information management table. In the shown example, a text “process target: document including text data” is shown in the target information portion 125.

Information on a form of data that is not the target of the process of the plug-in 30 is shown in the non-target information portion 126. In addition, two non-target information portions 126 are shown in the plug-in information portion 121 related to “read out”. A text “non-process target: image document not including text data” is shown in the non-target information portion 126 on an upper side out of the two non-target information portions 126. In addition, a text “non-process target: app document not including text data” is shown in the non-target information portion 126 on a lower side out of the two non-target information portions 126.

The enabler plug-in reception portion 127 is used for receiving the request for the information on the enabler plug-in. The plug-in 30 of a target for which the request for information is received by the enabler plug-in reception portion 127 is the plug-in 30 having the relationship of the enabler plug-in with the data of the form shown in the non-target information portion 126. In addition, in the shown example, the enabler plug-in reception portion 127 associated with the non-target information portion 126 on the upper side out of the two non-target information portions 126 and the enabler plug-in reception portion 127 associated with the non-target information portion 126 on the lower side out of the two non-target information portions 126 are shown.

In the present exemplary embodiment, “OCR” (refer to FIG. 5) is the plug-in 30 having “process target” including “image document not including text data” that is not “process target” of “read out” which is the designated plug-in, and having “output form” associated with “image document including text data” that is “process target” of “read out”. That is, in the present exemplary embodiment, the plug-in 30 having the relationship of the enabler plug-in with “read out” which is the designated plug-in is included. In this case, in the information output process, a determination that the data for which the process of the designated plug-in is not available is determined is made (YES in S102 in FIG. 6), and the enabler plug-in reception portion 127 as an example of the enabler plug-in reception information is displayed in the plug-in information portion 121.

In a case where the data for which the process of the designated plug-in is not available is not determined, that is, in a case where the plug-in 30 having the relationship of the enabler plug-in with the designated plug-in is not included, the enabler plug-in reception portion 127 is not displayed in the plug-in information portion 121.

The information on the form of the data output by executing the process using the plug-in 30 is shown in the output information portion 128. The output information portion 128 includes information shown in “output form” of the plug-in information management table. In the shown example, a text “output form: voice data” is shown in the output information portion 128.

The execution reception portion 129 is used for receiving a request for execution of the process using the plug-in 30 from the user. In a case where the execution reception portion 129 is selected by the user, the execution unit 104 executes the process of the plug-in 30 on the predetermined data in the management server 10. A result obtained by execution is output to the user terminal 20.

Any of the icon portion 122, the content information portion 123, the target information portion 125, the non-target information portion 126, and the output information portion 128 is an example of the information on the designated plug-in. In addition, in a broad sense, the plug-in information portion 121 is regarded as the information on the designated plug-in.

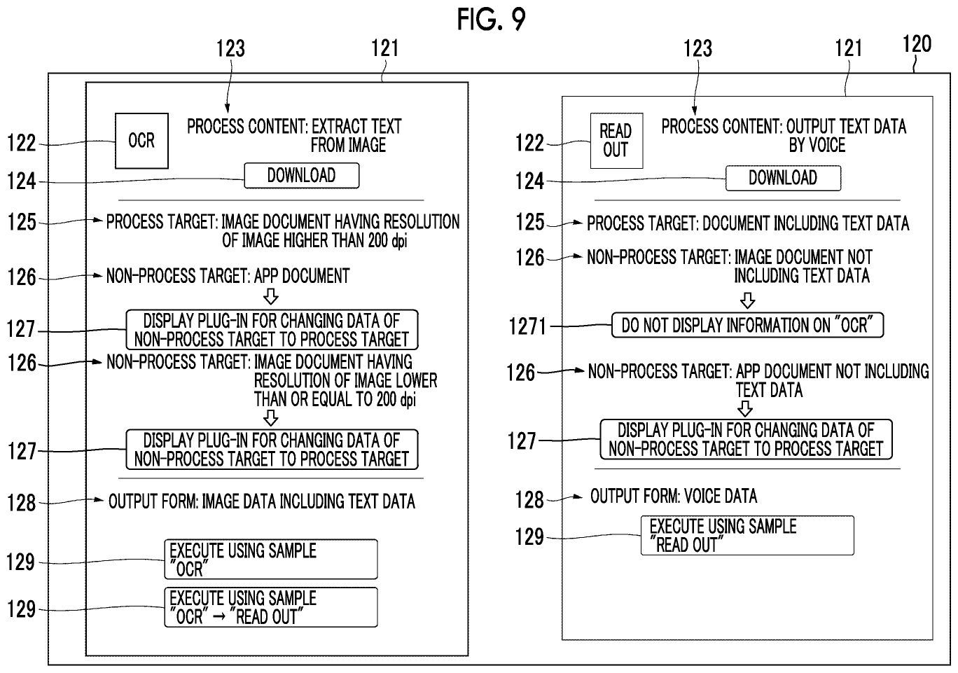

Here, for example, in a case where the user selects the enabler plug-in reception portion 127 on the upper side out of the two enabler plug-in reception portions 127, two plug-in information portions 121 are displayed on the plug-in screen 120 as shown in FIG. 9. The plug-in information portion 121 displayed on a right side out of the two plug-in information portions 121 is the plug-in information portion 121 related to “read out” that is the designated plug-in. In addition, the plug-in information portion 121 displayed on a left side out of the two plug-in information portions 121 is the plug-in information portion 121 related to “OCR” that is the enabler plug-in. The enabler plug-in that is a target of the plug-in information portion 121 is the plug-in 30 having the relationship of the enabler plug-in with “image document not including text data” shown in the non-target information portion 126 of the plug-in information portion 121 of “read out”. In addition, the plug-in information portion 121 of “OCR” is displayed in a form in which the user views the plug-in information portion 121 of “OCR” as being included before the plug-in information portion 121 of “read out”.

In addition, in the present exemplary embodiment, in a case where the enabler plug-in reception portion 127 of the plug-in information portion 121 of the designated plug-in is selected, the plug-in information portion 121 of the enabler plug-in is displayed. By doing so, the displayed plug-in information portion 121 of the enabler plug-in is output in a form associated with the information on the designated plug-in.

In addition, in the plug-in information portion 121 related to “read out”, a non-display reception portion 1271 is displayed instead of the enabler plug-in reception portion 127 selected by the user. In a case where the non-display reception portion 1271 is selected by the user, the plug-in information portion 121 of “OCR” is not displayed.

In addition, two non-target information portions 126 are shown in the plug-in information portion 121 related to “OCR”. A text “non-process target: app document” is shown in the non-target information portion 126 on an upper side out of the two non-target information portions 126. In addition, a text “non-process target: image document having resolution of image lower than or equal to 200 dpi” is shown in the non-target information portion 126 on a lower side out of the two non-target information portions 126. In addition, the enabler plug-in reception portion 127 associated with the non-target information portion 126 on the upper side out of the two non-target information portions 126 and the enabler plug-in reception portion 127 associated with the non-target information portion 126 on the lower side are shown in the plug-in information portion 121 related to “OCR”.

In addition, two execution reception portions 129 are shown in the plug-in information portion 121 related to “OCR”. A text “execute using sample “OCR”” is shown in the execution reception portion 129 on an upper side out of the two execution reception portions 129. In a case where this execution reception portion 129 is selected by the user, the execution unit 104 outputs, to the user terminal 20, a result of execution of the process of the plug-in 30 of “OCR” on the predetermined data in the management server 10. In addition, a text “execute using sample “OCR”→“read out”” is shown in the execution reception portion 129 on a lower side out of the two execution reception portions 129. In a case where this execution reception portion 129 is selected by the user, the execution unit 104 outputs, to the user terminal 20, the result of execution of the process of the plug-in 30 of “OCR” on the predetermined data in the management server 10. Furthermore, the execution unit 104 outputs, to the user terminal 20, a result of execution of the process of the plug-in 30 of “read out” on the data processed by the plug-in 30 of “OCR”.

Any of the icon portion 122, the content information portion 123, the target information portion 125, the non-target information portion 126, and the output information portion 128 shown in the plug-in information portion 121 of “OCR” in FIG. 9 is an example of the information on the enabler plug-in. In addition, in a broad sense, the plug-in information portion 121 of “OCR” is regarded as the information on the enabler plug-in.

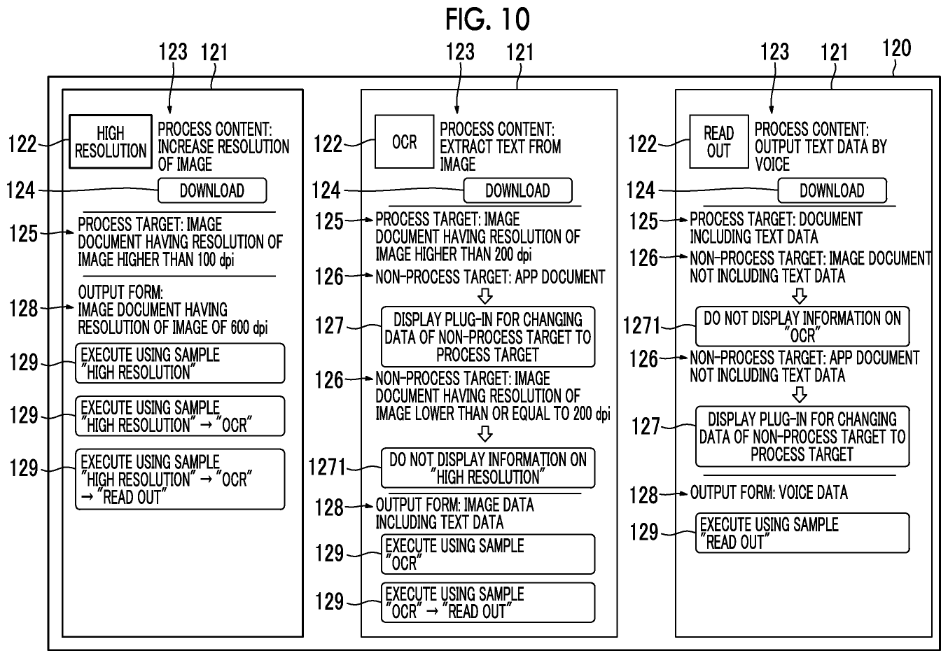

Here, for example, in a case where the user selects the enabler plug-in reception portion 127 on a lower side out of the two enabler plug-in reception portions 127, three plug-in information portions 121 are displayed on the plug-in screen 120 as shown in FIG. 10. The plug-in information portion 121 displayed on a rightmost side among the three plug-in information portions 121 is the plug-in information portion 121 related to “read out”. In addition, the plug-in information portion 121 displayed at a center among the three plug-in information portions 121 is the plug-in information portion 121 related to “OCR”. Furthermore, the plug-in information portion 121 displayed on a leftmost side among the three plug-in information portions 121 is the plug-in information portion 121 related to “high resolution”. The enabler plug-in that is a target of the plug-in information portion 121 is the plug-in 30 having the relationship of the enabler plug-in with “image document having resolution of image lower than or equal to 200 dpi” shown in the non-target information portion 126 of the plug-in information portion 121 of “OCR”. In addition, the plug-in information portion 121 of “high resolution” is displayed in a form in which the user views the plug-in information portion 121 of “high resolution” as being included before the plug-in information portion 121 of “OCR” and the plug-in information portion 121 of “read out”.

In addition, in the plug-in information portion 121 related to “OCR”, the non-display reception portion 1271 is displayed instead of the enabler plug-in reception portion 127 selected by the user. Ina case where the non-display reception portion 1271 is selected by the user, the plug-in information portion 121 of “high resolution” is not displayed.

In addition, three execution reception portions 129 are shown in the plug-in information portion 121 related to “high resolution”. A text “execute using sample “high resolution”” is shown in the execution reception portion 129 on an uppermost side among the three execution reception portions 129. In addition, a text “execute using sample “high resolution”→“OCR”” is shown in the execution reception portion 129 at a center among the three execution reception portions 129. In addition, a text “execute using sample “high resolution”→“OCR”→“read out”” is shown in the execution reception portion 129 on a lowermost side among the three execution reception portions 129.

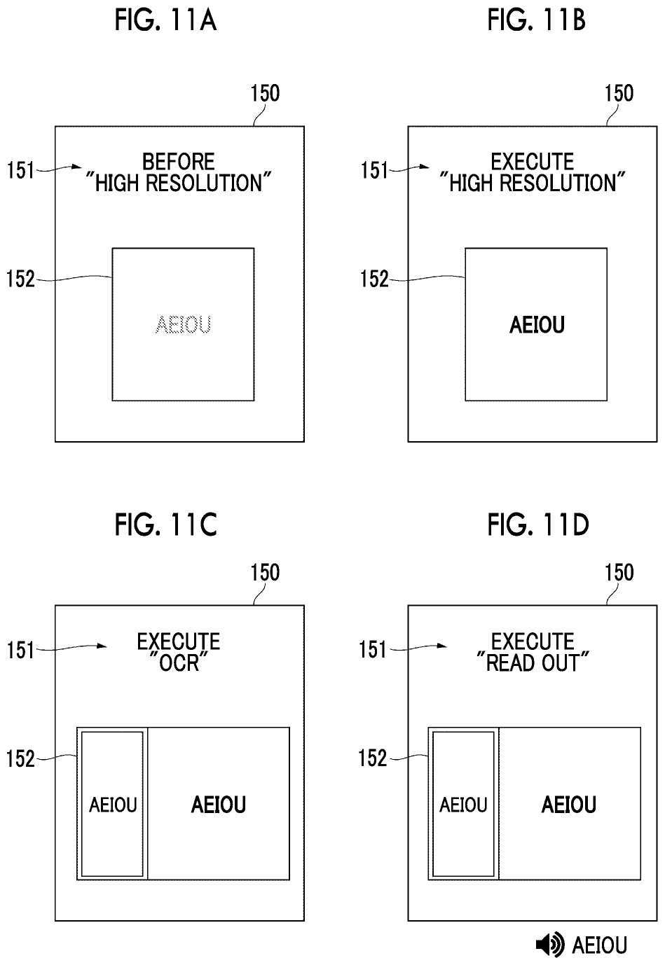

Here, for example, the user selects the execution reception portion 129 showing the text “execute using sample “high resolution”→“OCR”→“read out””. In this case, as shown in FIG. 11A, a result screen 150 is displayed on the user terminal 20. The result screen 150 is a screen showing the result of execution of the process of the plug-in 30. A progress description portion 151 and a target file 152 are displayed on the result screen 150.

Information for describing a progress of the process of the plug-in 30 is shown in the progress description portion 151. In the shown example, a text “before “high resolution”” meaning before executing the process of the plug-in 30 is shown.

A file of a target processed by the plug-in 30 is shown in the target file 152. In the shown example, information “aeiou” is shown in the target file 152 in the image data format.

Next, in a case where the execution unit 104 executes the process of the plug-in 30 of “high resolution” on the target file 152, a content displayed on the result screen 150 is updated as shown in FIG. 11B. A text “execute “high resolution”” meaning execution of the process of the plug-in 30 of “high resolution” is shown in the progress description portion 151 shown in FIG. 11B. In addition, the information “aeiou” having a higher resolution of the image than “aeiou” shown in the target file 152 in FIG. 11A is shown in the target file 152 in the image data format.

Next, in a case where the execution unit 104 executes the process of the plug-in 30 of “OCR” on the target file 152 shown in FIG. 11B, the content displayed on the result screen 150 is updated as shown in FIG. 11C. A text “execute “OCR”” meaning execution of the process of the plug-in 30 of “OCR” is shown in the progress description portion 151 shown in FIG. 11C. In addition, the information “aeiou” is shown in the target file 152 in the image data format and a text data format.

Next, in a case where the execution unit 104 executes the process of the plug-in 30 of “read out” on the target file 152 shown in FIG. 11C, the content displayed on the result screen 150 is updated as shown in FIG. 11D. A text “execute “read out”” meaning execution of the process of the plug-in 30 of “read out” is shown in the progress description portion 151 shown in FIG. 11D. In addition, at this point, the information “aeiou” is output by voice from the user terminal 20.

In the present exemplary embodiment described above, in a case where the enabler plug-in reception portion 127 on the lower side out of the two enabler plug-in reception portions 127 is selected in the plug-in information portion 121 of “OCR” shown in FIG. 9, the plug-in information portion 121 of “high resolution” is displayed (refer to FIG. 10). Here, in a case where the enabler plug-in reception portion 127 on the upper side out of the two enabler plug-in reception portions 127 is selected in the plug-in information portion 121 of “OCR” shown in FIG. 9, the plug-in information portion 121 of “format conversion” (refer to FIG. 5) is displayed. Here, “format conversion” that is a target of the plug-in information portion 121 is the plug-in 30 having the relationship of the enabler plug-in with “app document” shown in the non-target information portion 126 of the plug-in information portion 121 of “OCR”. That is, in the present exemplary embodiment, information on different plug-ins 30 is output depending on the form of the data determined as the target of the process of the plug-in 30.

In addition, in the present exemplary embodiment described above, while the information on the plug-in 30 having the relationship of the enabler plug-in with the designated plug-in is displayed on the user terminal 20 in a case where any plug-in 30 among the plurality of plug-ins 30 is designated by the user, the invention is not limited thereto.

The processor 11 of the management server 10 may display, on the user terminal 20, information on the plug-in 30 of which the process is not available for specific data not processed by the designated plug-in and is available for data output by processing the specific data by the designated plug-in. Hereinafter, the plug-in 30 of which the process is not available for the specific data not processed by the plug-in and is available for the data output by processing the specific data by the plug-in will be referred to as an after-process enabler plug-in. In this case, the designated plug-in has the relationship of the enabler plug-in with the after-process enabler plug-in.

In a case where any plug-in 30 among the plurality of plug-ins 30 is designated by the user, the processor 11 of the management server 10 may determine whether or not the plug-in 30 having a relationship of the after-process enabler plug-in with the designated plug-in is present. In a case where the plug-in 30 having the relationship of the after-process enabler plug-in with the designated plug-in is present, the processor 11 may display, in the plug-in information portion 121 (refer to FIG. 8) related to the designated plug-in, information on a form in which a request for information on the after-process enabler plug-in from the user is receivable. In a case where the information on the after-process enabler plug-in is requested by the user by operating the user terminal 20 by the user, the processor 11 may display the plug-in information portion 121 related to the after-process enabler plug-in on the user terminal 20. Accordingly, the information on the after-process enabler plug-in is output in a form associated with the information on the designated plug-in.

Modification Example of Plug-In that is Display Target

Next, a modification example of the plug-in 30 that is a target to be displayed on the user terminal 20 will be described.

In the present exemplary embodiment described above, the information on the designated plug-in, the information on the enabler plug-in, the information on the after-process enabler plug-in, and the like are displayed on the user terminal 20. Here, the plug-in 30 that is a target for displaying information on the user terminal 20 is not limited to the plug-in 30 described above.

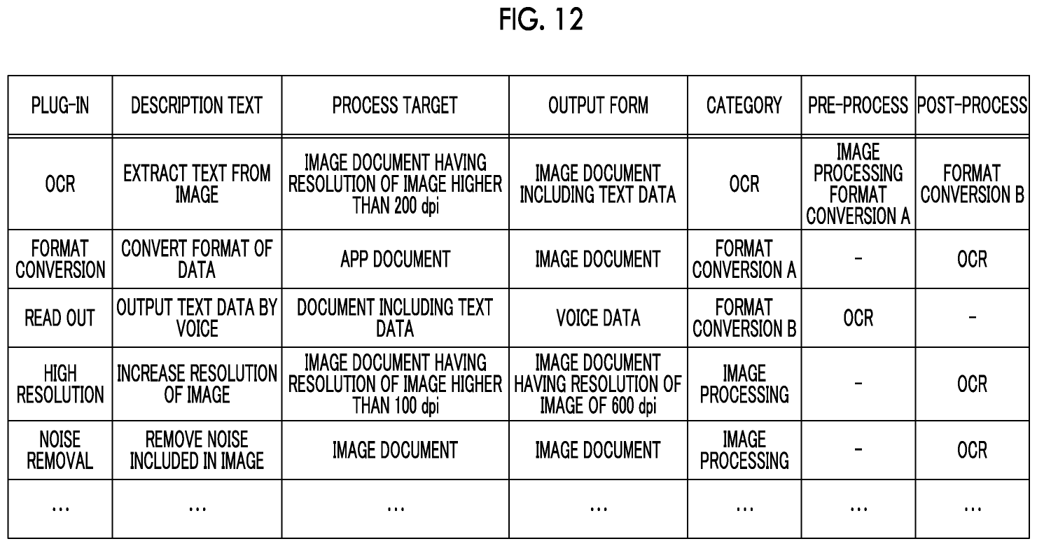

FIG. 12 is a diagram showing a plug-in information management table as a modification example.

In the plug-in information management table shown in FIG. 12, “plug-in”, “description text”, “process target”, and “output form” are shown in the same manner as the plug-in information management table shown in FIG. 5.

In addition, items divided by the content of the process executed by “plug-in” are shown in “category” of the plug-in information management table shown in FIG. 12.

In addition, “category” of the plug-in 30 that affects the process of “plug-in” is shown in “pre-process” of the plug-in information management table. More specifically, “category” of the plug-in 30 that affects the process of “plug-in” by executing a process in advance before the process of “plug-in” on data of a target on which the process of “plug-in” is executed is shown in “pre-process”. Hereinafter, the plug-in 30 that affects the process of the plug-in 30 will be referred to as a pre-process plug-in.

In addition, “category” of the plug-in 30 that is affected by the process of “plug-in” is shown in “post-process” of the plug-in information management table. More specifically, “category” of the plug-in 30 that is affected by executing the process of “plug-in” in advance before “post-process” on data of a target on which “post-process” is executed is shown in “post-process”. Hereinafter, the plug-in 30 that is affected by the process of the plug-in 30 will be referred to as a post-process plug-in.

Here, “pre-process” and “post-process” of the plug-in information management table will be described using “OCR” as an example.

In a case where a process of “format conversion” is executed on the app document before a process of “OCR” is executed, a form of a file for which the process of “OCR” is not available is changed to a form for which the process of “OCR” is available. In addition, in a case where a process of “high resolution” is executed on the image document before the process of “OCR” is executed, the resolution of the image is increased in the image document of a target on which the process of “OCR” is executed, compared to a case where the process of “high resolution” is not executed. In addition, in a case where a process of “noise removal” is executed on the image document before the process of “OCR” is executed, a noise included in the image of the image document of the target on which the process of “OCR” is executed is removed.

Thus, “format conversion A” that is “category” of “format conversion” is determined as “pre-process” of “OCR” as “category” of the plug-in 30 affecting the process of “OCR”. In addition, “image processing” that is “category” of “high resolution” and “noise removal” is determined as “pre-process” of “OCR” as “category” of the plug-in 30 affecting the process of “OCR”. In addition, “OCR” that is the category of “OCR” is determined as “post-process” of “format conversion”, “high resolution”, and “noise removal” as “category” of the plug-in 30 affected by processes of “format conversion A” and “image processing”.

In addition, in a case where new text data is included in the image document by executing the process of “OCR” on the image document before a process of “read out” is executed, the new text data is output as a voice by “read out”. Thus, “OCR” that is “category” of “OCR” is determined as “pre-process” of “readout” as “category” of the plug-in 30 affecting the process of “read out”. In addition, “format conversion B” that is “category” of “read out” is determined as “post-process” of “OCR” as “category” of the plug-in 30 affected by the process of “OCR”.

Here, “category”, “pre-process”, and “post-process” of the plug-in information management table are determined by a manager of the notification system 1.

Next, a flow of information output process as a modification example will be described.

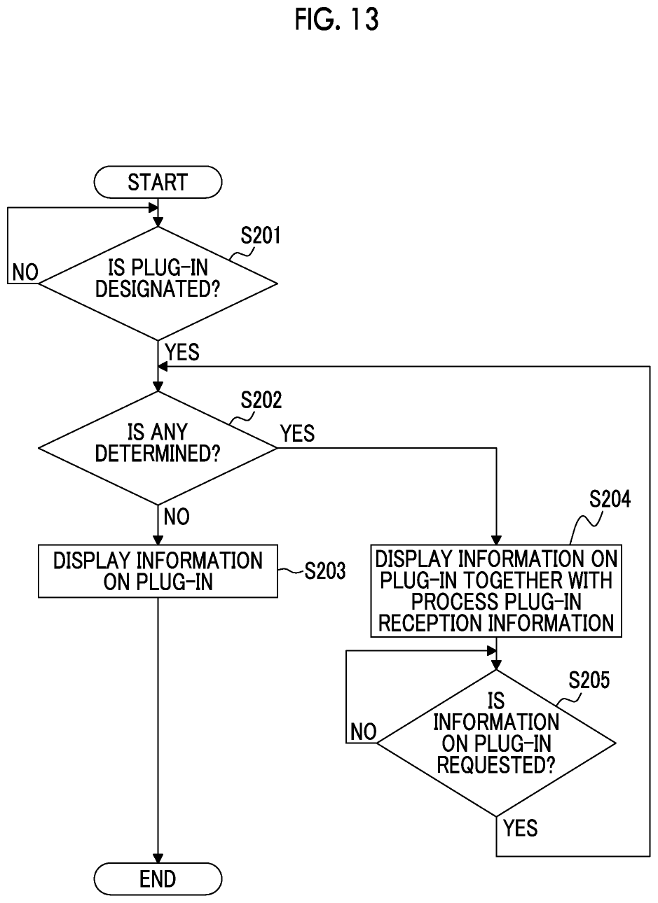

FIG. 13 is a flowchart showing the flow of information output process as the modification example.

The acquisition unit 101 of the management server 10 determines whether or not any plug-in 30 among the plurality of plug-ins 30 is designated by the user in the user terminal 20 (S201). While a negative result continues, the acquisition unit 101 repeats a process of step S201.

Meanwhile, in a case where any plug-in 30 is designated by the user (YES in S201), the specifying unit 103 determines whether or not any of the pre-process plug-in and the post-process plug-in is determined for the designated plug-in (S202). The specifying unit 103 refers to the plug-in information management table (refer to FIG. 12) stored in the storage unit 102. The determination is performed based on whether or not “category” is associated with any of “pre-process” and “post-process” of the designated plug-in.

In a case where the specifying unit 103 determines that none of the pre-process plug-in and the post-process plug-in is determined for the designated plug-in (NO in S202), the specifying unit 103 extracts the information on the designated plug-in from the storage unit 102. The extracted information is transmitted to the output unit 105. The output unit 105 displays the acquired information on the designated plug-in on the user terminal 20 (S203).

In addition, in a case where the specifying unit 103 determines that any of the pre-process plug-in and the post-process plug-in is determined for the designated plug-in (YES in S202), the specifying unit 103 transmits the information on the designated plug-in and process plug-in reception information to the output unit 105. The process plug-in reception information is information on a form in which a request for information on the pre-process plug-in or information on the post-process plug-in from the user is receivable. The output unit 105 displays the acquired information on the designated plug-in and the process plug-in reception information on the user terminal 20 (S204).

The acquisition unit 101 determines whether or not the request for the information on the pre-process plug-in or the information on the post-process plug-in from the user is acquired (S205). While a negative result continues, the acquisition unit 101 repeats a process of step S205.

Meanwhile, in a case where the acquisition unit 101 acquires the request for the information on the pre-process plug-in or the information on the post-process plug-in (YES in S205), a process from step S202 is performed by targeting the requested plug-in 30. That is, in a case where the specifying unit 103 determines that any of the pre-process plug-in and the post-process plug-in is determined for the requested plug-in 30 (YES in S202), the specifying unit 103 displays the information on the requested plug-in and the process plug-in reception information on the plug-in 30 having a relationship of the pre-process plug-in or the post-process plug-in with the plug-in (S204). In addition, in a case where the specifying unit 103 determines that none of the pre-process plug-in and the post-process plug-in is determined for the requested plug-in 30 (NO in S202), the specifying unit 103 displays the information on the requested plug-in (S203).

Next, images displayed on the user terminal 20 in the information output process as the modification example will be described.

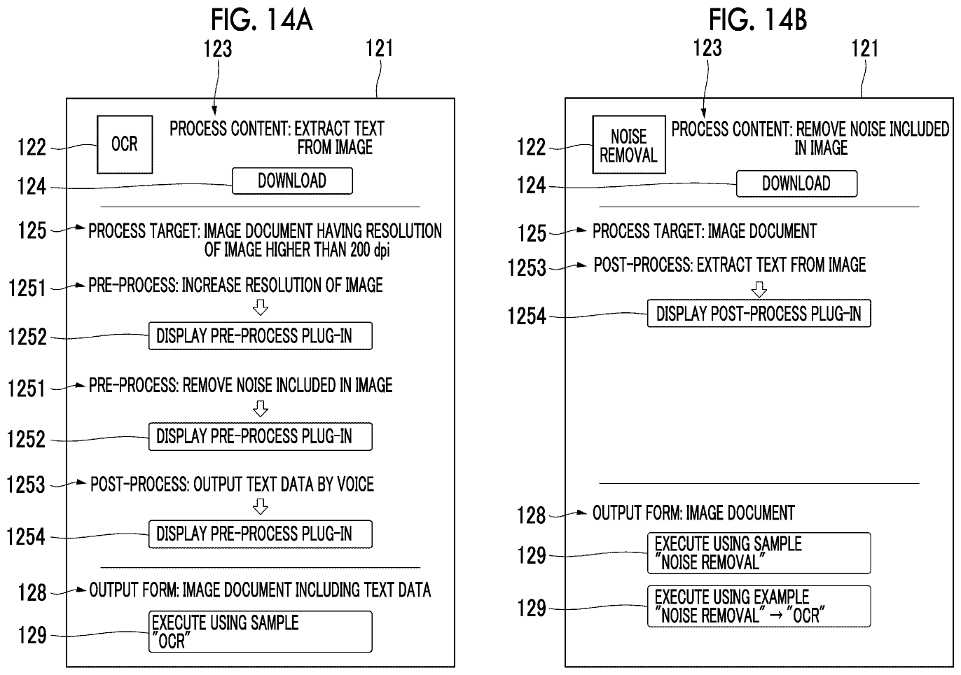

For example, in a case where the user selects “OCR” in the plug-in list portion 112 on the plug-in designation screen 110 (refer to FIG. 7), the plug-in information portion 121 of “OCR” is displayed on the user terminal 20 as shown in FIG. 14A. The icon portion 122, the content information portion 123, the download reception portion 124, the target information portion 125, the output information portion 128, and the execution reception portion 129 are displayed in the plug-in information portion 121. In addition, a pre-process information portion 1251, a pre-process plug-in reception portion 1252, a post-process information portion 1253, and a post-process plug-in reception portion 1254 are displayed in the plug-in information portion 121.

A content of a process executed by the pre-process plug-in is shown in the pre-process information portion 1251. The pre-process information portion 1251 of the present exemplary embodiment includes information shown in “description text” of the pre-process plug-in in the plug-in information management table (refer to FIG. 12). In addition, two pre-process information portions 1251 are shown in the plug-in information portion 121 of “OCR”. A text “pre-process: increase resolution of image” that is a content of the process executed by “high resolution” is shown in the pre-process information portion 1251 on an upper side out of the two pre-process information portions 1251. In addition, a text “pre-process: remove noise included in image” that is a content of the process executed by “noise removal” is shown in the pre-process information portion 1251 on a lower side out of the two pre-process information portions 1251.

The pre-process plug-in reception portion 1252 as an example of the process plug-in reception information is used for receiving a request for the information on the pre-process plug-in. In addition, in the shown example, the pre-process plug-in reception portion 1252 associated with the pre-process information portion 1251 on the upper side out of the two pre-process information portions 1251 and the pre-process plug-in reception portion 1252 associated with the pre-process information portion 1251 on the lower side are shown. In a case where the pre-process plug-in reception portion 1252 is selected by the user, the plug-in information portion 121 of the pre-process plug-in that performs the process shown in the pre-process information portion 1251 associated with the selected pre-process plug-in reception portion 1252 is displayed.

A content of a process executed by the post-process plug-in is shown in the post-process information portion 1253. The post-process information portion 1253 of the present exemplary embodiment includes information shown in “description text” of the post-process plug-in in the plug-in information management table (refer to FIG. 12). In the shown example, a text “post-process: output text data by voice” that is a content of the process executed by “read out” is shown in the post-process information portion 1253.

The post-process plug-in reception portion 1254 as an example of the process plug-in reception information is used for receiving a request for the information on the post-process plug-in. In addition, the post-process plug-in reception portion 1254 is associated with the post-process information portion 1253. In a case where the post-process plug-in reception portion 1254 is selected by the user, the plug-in information portion 121 of the post-process plug-in that performs the process shown in the post-process information portion 1253 associated with the selected post-process plug-in reception portion 1254 is displayed.

Any of the icon portion 122, the content information portion 123, the target information portion 125, and the output information portion 128 is an example of the information on the designated plug-in. In addition, the pre-process information portion 1251 is an example of the information on the pre-process plug-in. In addition, the post-process information portion 1253 is an example of the information on the post-process plug-in.

Here, for example, in a case where the user selects the pre-process plug-in reception portion 1252 on a lower side out of two pre-process plug-in reception portions 1252, the plug-in information portion 121 of “noise removal” is displayed on the user terminal 20 as shown in FIG. 14B. The pre-process plug-in that is a target of the plug-in information portion 121 is the pre-process plug-in of which a content of the process is “pre-process: remove noise included in image” shown in the pre-process information portion 1251 of the plug-in information portion 121 of “OCR”. The icon portion 122, the content information portion 123, the download reception portion 124, the target information portion 125, the post-process information portion 1253, the post-process plug-in reception portion 1254, the output information portion 128, and the execution reception portion 129 are displayed in the plug-in information portion 121.

A content of the process of “OCR” having the relationship of the post-process plug-in with “noise removal” is shown in the post-process information portion 1253 of the plug-in information portion 121 of “noise removal”. In addition, in a case where the post-process plug-in reception portion 1254 is selected by the user, the plug-in information portion 121 shown in FIG. 14A is displayed again on the user terminal 20.

In addition, two execution reception portions 129 are shown in the plug-in information portion 121 related to “noise removal”. A text “execute using sample “noise removal”” is shown in the execution reception portion 129 on an upper side out of the two execution reception portions 129. In a case where this execution reception portion 129 is selected by the user, the execution unit 104 outputs, to the user terminal 20, a result of execution of the process of the plug-in 30 of “noise removal” on the predetermined data in the management server 10. In addition, a text “execute using sample “noise removal”→“OCR”” is shown in the execution reception portion 129 on a lower side out of the two execution reception portions 129. In a case where this execution reception portion 129 is selected by the user, the execution unit 104 outputs, to the user terminal 20, the result of execution of the process of the plug-in 30 of “noise removal” on the predetermined data in the management server 10. Furthermore, the execution unit 104 outputs, to the user terminal 20, the result of execution of the process of the plug-in 30 of “OCR” on the data processed by the plug-in 30 of “noise removal”.

In the plug-in information portion 121 shown in FIG. 14B, any of the icon portion 122, the content information portion 123, the target information portion 125, and the output information portion 128 is an example of the information on the pre-process plug-in. In addition, the post-process information portion 1253 is an example of the information on the post-process plug-in.

As described above, information output by the processor 11 of the management server 10 is not limited to the information on the designated plug-in and the information on the enabler plug-in or the information on the after-process enabler plug-in. The processor 11 may output the information on the designated plug-in and the information on the pre-process plug-in or the information on the post-process plug-in. That is, the processor 11 may output information on first software and output information on second software executing a process to be performed before or after a process executed by the first software, in a form associated with the information on the first software. For example, the designated plug-in is exemplified as the first software. In addition, for example, the enabler plug-in, the after-process enabler plug-in, the pre-process plug-in, and the post-process plug-in are exemplified as the second software. That is, the plug-in 30 executing the process to be performed before or after the process executed by the designated plug-in includes the plug-in 30 having the relationship of any of the enabler plug-in, the after-process enabler plug-in, the pre-process plug-in, and the post-process plug-in with the designated plug-in 30. In addition, hereinafter, the plug-in 30 executing the process to be performed before or after the process executed by the designated plug-in will be referred to as a process plug-in.

In addition, in other words, the second software executing the process to be performed before or after the process executed by the first software is regarded as the second software satisfying a condition that is determined for a relationship between data processed by one software out of the first software or the second software and a process of the other software performed on the processed data. In addition, the determined condition is exemplified such that in the plug-in information management table, data of a form that is not “process target” of one of the first software and the second software is associated with “process target” of the other software, and data of a form that is “process target” of one software is associated with “output form” of the other software. In addition, the determined condition is exemplified such that in the plug-in information management table, “category” of the second software is associated with any of “pre-process” and “post-process” of the first software.

In addition, the second software executing the process to be performed before the process executed by the first software is regarded as software that performs a process of changing a form of data for which the process of the first software is not available, to a form of data for which the process of the first software is available. In addition, the second software executing the process to be performed after the process executed by the first software is regarded as software of which a process is not available for specific data not processed by the first software and is available for data output by processing the specific data by the first software.

In addition, in the present exemplary embodiment, the process of one software out of the first software or the second software is a process of changing a form of data for which the process of the other software is not available, to a form of data for which the process of the other software is available.

In addition, the processor 11 of the present exemplary embodiment outputs the information on the second software in a case where data for which the process of the first software is not available is determined.

In addition, in the present exemplary embodiment, as described above, the displayed enabler plug-in of a target of the enabler plug-in reception portion 127 varies depending on which of the two enabler plug-in reception portions 127 is selected in the plug-in information portion 121 of “OCR” shown in FIG. 9. In other words, the processor 11 outputs information on different second software depending on a form of data determined as a target of the process of the first software.

In addition, in the present exemplary embodiment, the processor 11 outputs results of the processes of the first software and the second software performed on the data.

Particularly, in the present exemplary embodiment, the processor 11 outputs the results of the processes of the first software and the second software performed on the data and a result of execution of the process of any one software out of the first software or the second software without executing the process of the other software.

In the present exemplary embodiment, the pre-process information portion 1251, the pre-process plug-in reception portion 1252, the post-process information portion 1253, and the post-process plug-in reception portion 1254 are not displayed in the plug-in information portion 121 shown in FIG. 8. In addition, while the non-target information portion 126 and the enabler plug-in reception portion 127 are not displayed in the plug-in information portion 121 shown in FIG. 14A, the invention is not limited thereto. The target information portion 125, the non-target information portion 126, the enabler plug-in reception portion 127, the pre-process information portion 1251, the pre-process plug-in reception portion 1252, the post-process information portion 1253, and the post-process plug-in reception portion 1254 may be displayed in one plug-in information portion 121. Furthermore, the information on the form in which the request for the information on the after-process enabler plug-in from the user is receivable may be displayed in one plug-in information portion 121.

In addition, while an example of displaying one plug-in information portion 121 is described using FIG. 14B, the invention is not limited thereto. Not only the plug-in information portion 121 of “noise removal” but also the plug-in information portion 121 of “OCR” (refer to FIG. 14A) may be displayed on the user terminal 20. That is, one plug-in information portion 121 may be displayed on the user terminal 20, or a plurality of plug-in information portions 121 may be displayed on the user terminal 20.

Modification Example of Process of Provision Unit 106

Next, a modification example of a process of the provision unit 106 will be described.

In the present exemplary embodiment described above, in a case where the download reception portion 124 of the plug-in information portion 121 (refer to FIG. 8) is selected, the provision unit 106 provides one plug-in 30 to the user terminal 20. Here, a form of provision of the plug-in 30 by the provision unit 106 is not limited to the above example.

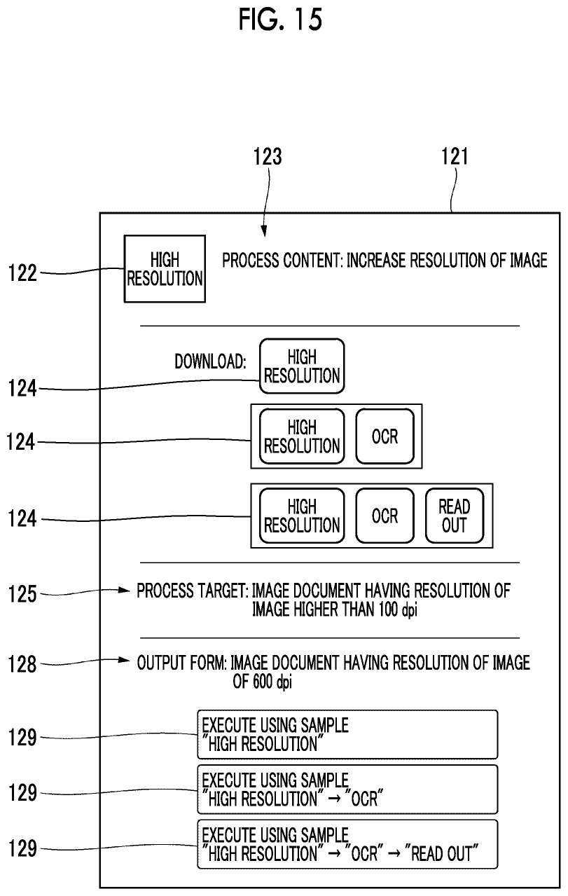

FIG. 15 is a diagram showing a modification example of the plug-in information portion 121 of “high resolution” in FIG. 10. In the plug-in information portion 121 shown in FIG. 15, configurations identical to the plug-in information portion 121 of “high resolution” in FIG. 10 may not be described.

Three download reception portions 124 are displayed in the plug-in information portion 121 shown in FIG. 15.

An icon of the plug-in 30 of “high resolution” is shown in the download reception portion 124 on an uppermost side among the three download reception portions 124. In a case where this download reception portion 124 is selected by the user, the provision unit 106 provides the plug-in 30 of “high resolution” to the user terminal 20.

The icon of the plug-in 30 of “high resolution” and an icon of the plug-in 30 of “OCR” are shown in a box in the download reception portion 124 at a center among the three download reception portions 124. In a case where this download reception portion 124 is selected by the user, the provision unit 106 provides the plug-in 30 of “high resolution” and the plug-in 30 of “OCR” to the user terminal 20.

The icon of the plug-in 30 of “high resolution”, the icon of the plug-in 30 of “OCR”, and the icon of the plug-in 30 of “read out” are shown in a box in the download reception portion 124 on a lowermost side among the three download reception portions 124. In a case where this download reception portion 124 is selected by the user, the provision unit 106 provides the plug-in 30 of “high resolution”, the plug-in 30 of “OCR”, and the plug-in 30 of “read out” to the user terminal 20.

As described above, the enabler plug-in, the after-process enabler plug-in, the pre-process plug-in, or the post-process plug-in may be shown in association with the designated plug-in in the plug-in information portion 121. In addition, images showing a plurality of associated plug-ins 30 may be displayed in a form in which requests for downloading the plurality of plug-ins 30 from the user are receivable.

Particularly, in the present exemplary embodiment, the plug-in information portion 121 of “high resolution” is displayed by selecting the enabler plug-in reception portion 127 in the plug-in information portion 121 of “OCR” (refer to FIG. 9) that is displayed through the plug-in information portion 121 of “read out” (refer to FIG. 8). In this case, as shown in FIG. 15, the download reception portion 124 in which the icon of the plug-in 30 of “high resolution”, the icon of the plug-in 30 of “OCR”, and the icon of the plug-in 30 of “read out” are shown is displayed. Accordingly, in the plug-in information portion 121, the information on the plug-in 30 that is a target of the plug-in information portion 121 passed through until this plug-in information portion 121 is displayed may be shown.

Management Screen

Next, a management screen 130 for managing the document file in the document handling software of the present exemplary embodiment will be described. In the following description, display of each image on the user terminal 20 and the process of each plug-in 30 executed in the user terminal 20 are implemented through execution of the application program by the processor 11 of the user terminal 20. In addition, each image described below is displayed on the user terminal 20.

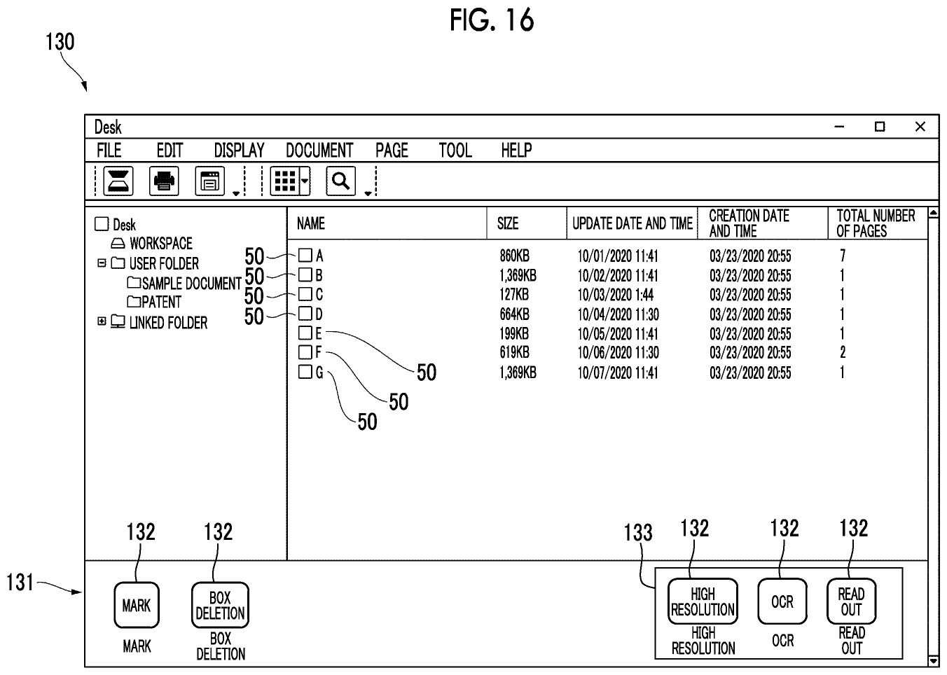

FIG. 16 is a diagram showing the management screen 130. Hereinafter, an assumption that the plug-in 30 is downloaded to the user terminal 20 by selecting the download reception portion 124 on the lowermost side among the three download reception portions 124 in the plug-in information portion 121 shown in FIG. 15 will be made.

A file 50 of a target managed in the document handling software is shown on the management screen 130. In addition, a toolbar 131 is displayed on the management screen 130. A plug-in icon 132 that is the icon of the plug-in 30 is displayed in the toolbar 131. In the shown example, five plug-in icons 132 are displayed in the toolbar 131. More specifically, the plug-in icon 132 of “mark”, the plug-in icon 132 of “box deletion”, the plug-in icon 132 of “high resolution”, the plug-in icon 132 of “OCR”, and the plug-in icon 132 of “read out” are displayed in the toolbar 131. The plug-in icon 132 is an example of the information on the plug-in 30.

Here, as described above, the plug-in 30 of “high resolution”, the plug-in 30 of “OCR”, and the plug-in 30 of “read out” are downloaded to the user terminal 20 by selecting the download reception portion 124 of the plug-in information portion 121 shown in FIG. 15. In addition, the plug-in 30 of “high resolution” has the relationship of the enabler plug-in and the relationship of the pre-process plug-in with the plug-in 30 of “OCR”. In addition, the plug-in 30 of “OCR” has the relationship of the enabler plug-in and the relationship of the pre-process plug-in with the plug-in 30 of “read out”. In other words, the plug-in 30 of “read out” has the relationship of the after-process enabler plug-in and the relationship of the post-process plug-in with the plug-in 30 of “OCR”. In addition, the plug-in 30 of “OCR” has the relationship of the after-process enabler plug-in and the relationship of the post-process plug-in with the plug-in 30 of “high resolution”.

In addition, a box image 133 that is formed in a box shape is shown in the toolbar 131. In addition, the plug-in icon 132 of “high resolution”, the plug-in icon 132 of “OCR”, and the plug-in icon 132 of “read out” are included inside the box image 133. Accordingly, each of the plug-in icon 132 of “high resolution”, the plug-in icon 132 of “OCR”, and the plug-in icon 132 of “read out” is shown in an associated form.

In a case where the plug-in icon 132 of “high resolution” is selected by the user, the processor 11 of the user terminal 20 executes the process of “high resolution” on the file 50. In addition, in a case where the plug-in icon 132 of “OCR” is selected by the user, the processor 11 executes the process of “OCR” on the file 50. In addition, in a case where the plug-in icon 132 of “read out” is selected by the user, the processor 11 executes the process of “read out” on the file 50.

As described above, in the present exemplary embodiment, a function of outputting the information on the first software and a function of outputting, in the form associated with the information on the first software, the information on the second software executing the process to be performed before or after the process executed by the first software are implemented through execution of the application program by the processor 11 of the user terminal 20.

Modification Example of Execution Form of Process by Plug-In

Next, a modification example of a form of executing the process of the plug-in 30 by the processor 11 will be described.

In the present exemplary embodiment described above, in a case where one plug-in icon 132 is selected by the user, the processor 11 of the user terminal 20 executes the process of one plug-in 30. Here, the form of executing the process of the plug-in 30 by the processor 11 is not limited to the above example.

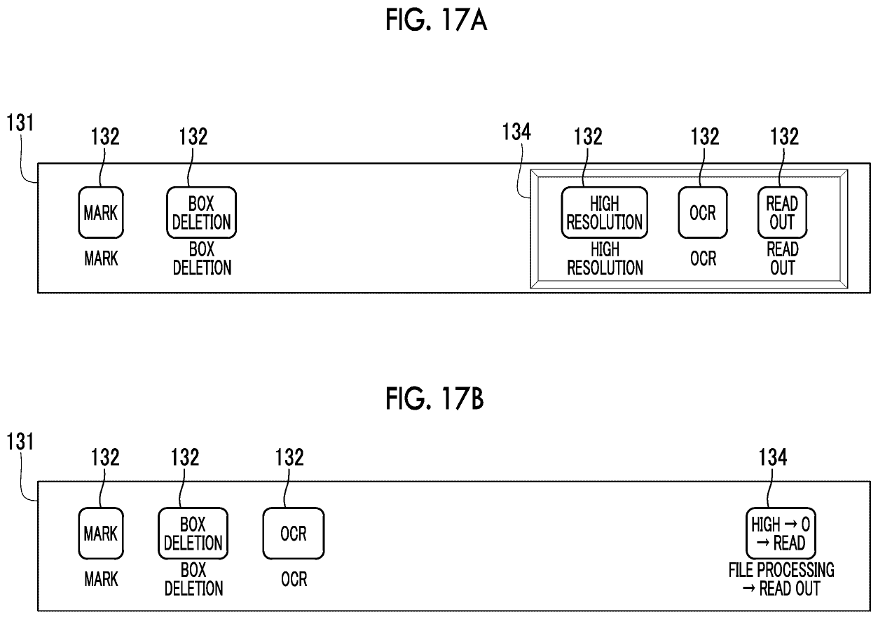

FIG. 17A and FIG. 17B are diagrams showing the toolbar 131 in the modification example. In FIG. 17A and FIG. 17B, the same configurations as in FIG. 16 may not be described. In addition, in FIG. 17A and FIG. 17B, only the toolbar 131 is shown, and parts of the management screen 130 other than the toolbar 131 are not shown.

As shown in FIG. 17A, the plug-in icon 132 of “mark”, the plug-in icon 132 of “box deletion”, the plug-in icon 132 of “high resolution”, the plug-in icon 132 of “OCR”, and the plug-in icon 132 of “read out” are displayed in the toolbar 131. In addition, a plural execution button 134 is displayed in the toolbar 131. The plural execution button 134 is a button for executing processes of a plurality of plug-ins 30 by the processor 11. In the shown example, the plug-in icon 132 of “high resolution”, the plug-in icon 132 of “OCR”, and the plug-in icon 132 of “read out” are displayed in the plural execution button 134.

In a case where the plural execution button 134 is selected by the user, the processor 11 of the user terminal 20 first executes the process of “high resolution” on the file 50. Next, the processor 11 executes the process of “OCR” on the file 50 on which the process of “high resolution” is executed. Furthermore, the processor 11 executes the process of “read out” on the file 50 on which the process of “OCR” is executed. That is, in a case where the plural execution button 134 is selected, the processor 11 executes the process of each plug-in 30 of which the icon is shown in the plural execution button 134.

In a case where any part of a region surrounded by the plural execution button 134 is selected, the processor 11 may execute all of the process of each plug-in 30 of which the icon is shown in the plural execution button 134.

In addition, in a case where a part in which the plug-in icon 132 is shown in the region surrounded by the plural execution button 134 is selected, the processor 11 may execute only the process of the plug-in 30 shown by the selected plug-in icon 132. In addition, in a case where a part in which the plug-in icon 132 is not shown in the region surrounded by the plural execution button 134 is selected, the processor 11 may execute the process of each plug-in 30 of which the icon is shown in the plural execution button 134.

In addition, the plural execution button 134 is not limited to a form shown in FIG. 17A and may be in a form shown in FIG. 17B. The plural execution button 134 shown in FIG. 17B is displayed in a shape of the icon. In addition, a text “high→O→read” that includes a part of a text shown in the plug-in icon 132 of each of “high resolution”, “OCR”, and “read out” is shown in the plural execution button 134. In a case where this plural execution button 134 is selected, the processor 11 executes the processes of “high resolution”, “OCR”, and “read out”. In addition, a display region of the plural execution button 134 has the same size as a display region of one plug-in icon 132. That is, the display region of the plural execution button 134 is smaller than a combined region of the display region of the plug-in icon 132 of “high resolution” and the display region of the plug-in icon 132 of “OCR” shown in FIG. 17A. The display region of the plural execution button 134 may be smaller than a total display region of two plug-in icons 132 and may be larger than the display region of one plug-in icon 132.

In addition, a text “file processing→read out” that is a content of a process executed by selecting the plural execution button 134 is shown in the plural execution button 134. This text may be edited by the user.

As described above, in the present exemplary embodiment, a function of displaying a specific reception image for receiving an instruction to execute a process of software from the user and a function of executing the processes of the first software and the second software in a case where the instruction is issued through the specific reception image are implemented through execution of the application program by the processor 11 of the user terminal 20. For example, the plural execution button 134 is exemplified as the specific reception image.

Particularly, in the present exemplary embodiment, a display region of the specific reception image is smaller than a combined region of a display region of a first reception image and a display region of a second reception image. For example, the plug-in icon 132 of the designated plug-in is exemplified as the first reception image. In addition, for example, the plug-in icon 132 of the enabler plug-in, the plug-in icon 132 of the after-process enabler plug-in, the plug-in icon 132 of the pre-process plug-in, and the plug-in icon 132 of the post-process plug-in are exemplified as the second reception image.

The plural execution button 134 (refer to FIGS. 17A and 17B) for executing the process of each of the plurality of plug-ins 30 may be displayed in the toolbar 131 on a condition that the processes of the plurality of plug-ins 30 are executed with a higher frequency than a predetermined frequency. While the predetermined frequency may be any frequency, for example, execution of the processes of the plurality of plug-ins 30 a specific number of times or more in one day is exemplified. While the specific number of times may be any number of times, for example, the specific number of times is three.

In addition, the plug-in 30 of which the process is not necessary may be present among the plurality of plug-ins 30 of which the processes are executed by selecting the plural execution button 134. An example of a case where the plurality of plug-ins 30 of which the processes are executed by selecting the plural execution button 134 are the plug-ins 30 of “high resolution”, “OCR”, and “read out” will be described. In a case where the resolution of the image included in the document file of a target of the processes is 600 dpi, the resolution of the image included in the document file of the target is not improved even by executing the process of “high resolution” on the document file of the target. In such a case, in a case where the plural execution button 134 is selected, the processor 11 may execute the processes of the plug-ins 30 of “OCR” and “read out” without executing the process of the plug-in 30 of “high resolution”. That is, in a case where the plug-in 30 that does not affect the processes of the other plug-ins 30 is present among the plurality of plug-ins 30 of which the processes are executed by selecting the plural execution button 134, the processor 11 may not execute the process of the non-affecting plug-in 30.

Modification Example of Display Form of Information in Toolbar

Next, a modification example of a form of displaying information in the toolbar 131 of the management screen 130 will be described.

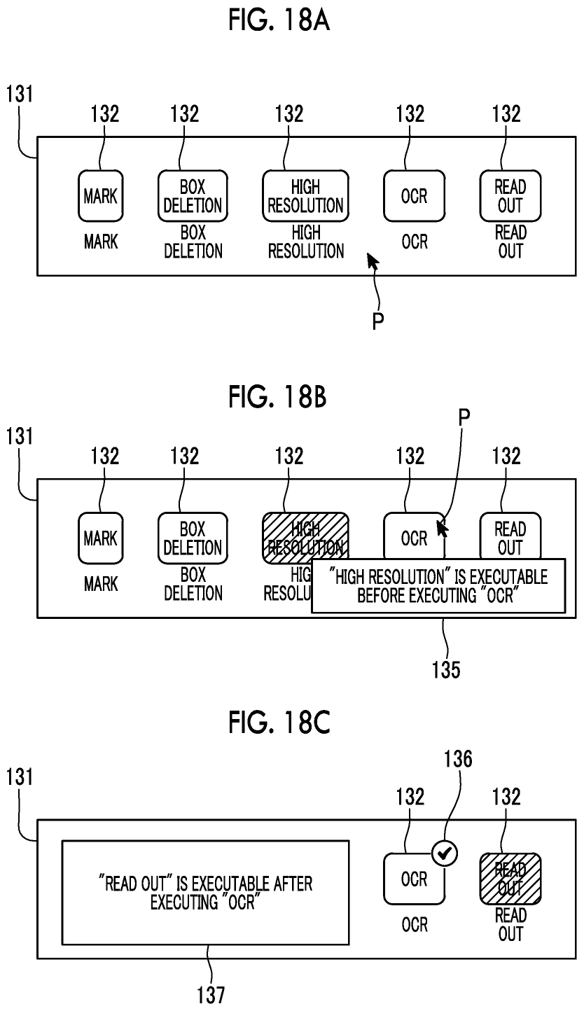

FIG. 18A to FIG. 18C are diagrams showing the toolbar 131 in the modification example. In FIG. 18A to FIG. 18C, only the toolbar 131 is shown, and parts of the management screen 130 other than the toolbar 131 are not shown.

As shown in FIG. 18A, the plug-in icon 132 of “mark”, the plug-in icon 132 of “box deletion”, the plug-in icon 132 of “high resolution”, the plug-in icon 132 of “OCR”, and the plug-in icon 132 of “read out” are displayed in the toolbar 131. In addition, a pointer P that is displayed in a display region corresponding to an operation of the input device 16 performed by the user is shown in a region in which the toolbar 131 is displayed.

Here, as shown in FIG. 18B, the pointer P is displayed in an overlapping manner with the display region of the plug-in icon 132 of “OCR” in accordance with the operation of the input device 16 performed by the user. In this case, a pre-process notification image 135 is displayed in a display region near the pointer P.

Information indicating that the plug-in 30 having a specific relationship with the plug-in 30 shown by the plug-in icon 132 overlapping with the pointer P is present is displayed in the pre-process notification image 135. For example, the relationship of the pre-process plug-in or the relationship of the enabler plug-in with the plug-in 30 is exemplified as the specific relationship with the plug-in 30. In the shown example, a text ““high resolution” is executable before executing “OCR”” is shown in the pre-process notification image 135. In addition, at this point, a display form of the plug-in icon 132 of “high resolution” that is a target of notification in the pre-process notification image 135 changes. More specifically, a display color of the plug-in icon 132 of “high resolution” changes.

In a case where the user selects the plug-in icon 132 of “OCR”, the processor 11 of the user terminal 20 executes the process of the plug-in 30 of “OCR” on the file 50. In this case, as shown in FIG. 18C, an execution completion image 136 that indicates that the process of the plug-in 30 is executed is displayed. The execution completion image 136 is displayed in an overlapping manner with the plug-in icon 132 of the plug-in 30 of which the process is executed.

In addition, a post-process notification image 1351 is displayed in the toolbar 131. Information indicating that the plug-in 30 having a specific relationship with the plug-in 30 of which the process is executed is present is displayed in the post-process notification image 1351. For example, the relationship of the post-process plug-in with the plug-in 30 or the relationship of the after-process enabler plug-in with the plug-in 30 is exemplified as the specific relationship with the plug-in 30. In the shown example, a text ““read out” is executable after executing “OCR”” is shown in the post-process notification image 1351. In addition, at this point, a display form of the plug-in icon 132 of “read out” that is a target of notification in the post-process notification image 1351 changes. More specifically, a display color of the plug-in icon 132 of “read out” changes.

Any of the pre-process notification image 135 shown in FIG. 18B and the post-process notification image 1351 shown in FIG. 18C is an example of the information on the plug-in 30.

As described above, in the present exemplary embodiment, in a case where the process of the plug-in 30 is executed by selecting the plug-in icon 132, the post-process notification image 1351 is displayed. In other words, in a case where the process of the first software is executed, the processor 11 outputs the information on the second software. Here, any plug-in 30 that is the target of notification in the post-process notification image 1351 is stored in the main memory 12 of the user terminal 20. In other words, the second software is software stored in a memory of a terminal that is used by the user and in which the process of the first software is executed.

Modification Example of Information Output Process

Next, a modification example of the information output process will be described.

In the present exemplary embodiment, the information output process performed by the management server 10 is described. Here, an apparatus of a target performing the information output process is not limited to the management server 10.

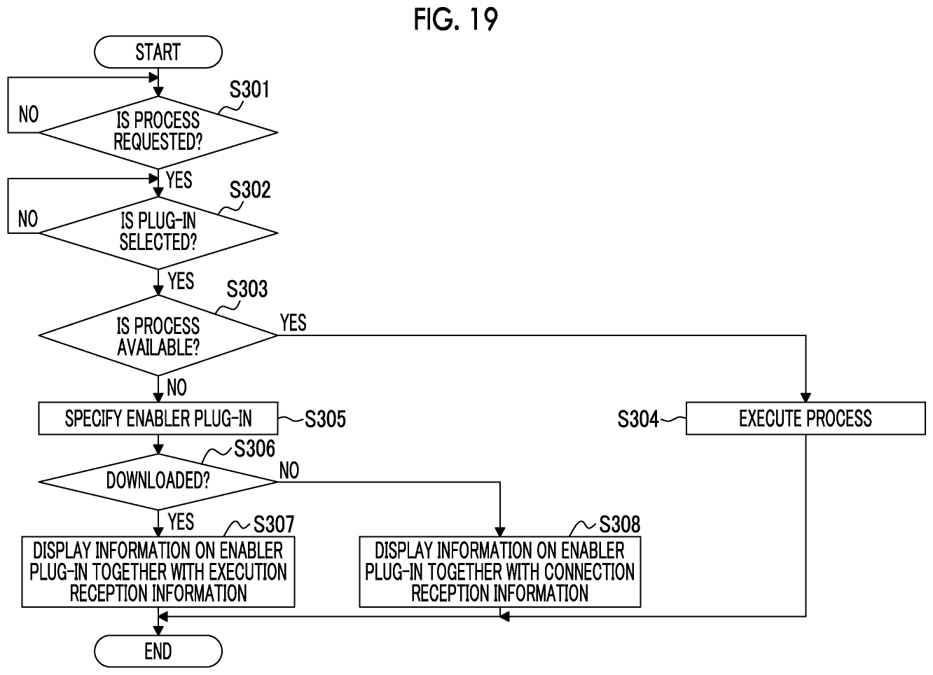

FIG. 19 is a flowchart showing a flow of information output process in the modification example. The information output process shown in FIG. 19 is executed by the processor 11 of the user terminal 20. Hereinafter, an assumption that the plug-in information management table shown in FIG. 12 is stored in the main memory 12 of the user terminal 20 will be made.

The processor 11 of the user terminal 20 determines whether or not execution of the process of the plug-in 30 is requested by the user (S301). The processor 11 performs the determination based on whether or not any plug-in icon 132 displayed in the toolbar 131 (refer to FIG. 18A) of the management screen 130 is selected. In addition, while a negative result continues, the processor 11 repeats a process of step S301.

Meanwhile, in a case where execution of the process of the plug-in 30 is requested (YES in S301), the processor 11 determines whether or not the file 50 of a target for which execution of the process of the plug-in 30 is requested is selected (S302). While a negative result continues, the processor 11 repeats a process of step S302.

An order of the processes of step S301 and step S302 may be changed.

In a case where the file 50 is selected (YES in S302), the processor 11 determines whether or not requested execution of the process of the plug-in 30 is available for the selected file 50 (S303). Hereinafter, the plug-in 30 of which execution of the process is requested by the user will be referred to as a requested plug-in. In addition, hereinafter, the file 50 selected by the user as the file 50 of a target on which the process of the requested plug-in is executed will be referred to as a selected file.

An example of a method in which the processor 11 determines whether or not execution of the process of the requested plug-in is available for the selected file will be described. The processor 11 refers to an information management table (refer to FIG. 12) stored in the main memory 12. A determination as to whether or not execution of the process of the requested plug-in is available for the selected file is performed based on whether or not the selected file is in a form of data included in “process target” of the requested plug-in.

In a case where the processor 11 determines that execution of the process of the requested plug-in is available (YES in S303), the processor 11 executes the process of the requested plug-in on the selected file (S304).

Meanwhile, in a case where the processor 11 determines that execution of the process of the requested plug-in is not available (NO in S303), the processor 11 specifies the plug-in 30 having the relationship of the enabler plug-in with the requested plug-in (S305). More specifically, in a case where the selected file is a target of the process of the requested plug-in, the processor 11 specifies the plug-in 30 having the relationship of the enabler plug-in with the requested plug-in.

An example of a method in which the processor 11 specifies the enabler plug-in will be described. The processor 11 refers to the information management table stored in the main memory 12. Here, “plug-in” having “process target” including a form of data of the selected file and having “output form” including “process target” of the requested plug-in is specified as the enabler plug-in.

The processor 11 determines whether or not the specified enabler plug-in is downloaded to the user terminal 20 (S306).

In a case where the enabler plug-in is downloaded (YES in S306), the processor 11 displays the information on the enabler plug-in on the user terminal 20 together with execution reception information (S307). The execution reception information is information on a form in which a request for execution of the process of the enabler plug-in from the user is receivable.

In addition, in a case where the enabler plug-in is not downloaded (NO in S306), the processor 11 displays the information on the enabler plug-in on the user terminal 20 together with connection reception information (S308). The connection reception information is information on a form in which a request for connection to a website on which the enabler plug-in is downloadable from the user is receivable.

Next, screens displayed on the user terminal 20 in the information output process shown in FIG. 19 will be described. Hereinafter, an assumption that the plug-in 30 of “high resolution” is downloaded to the user terminal 20, and that the plug-in 30 of “format conversion” is not downloaded to the user terminal 20 will be made.

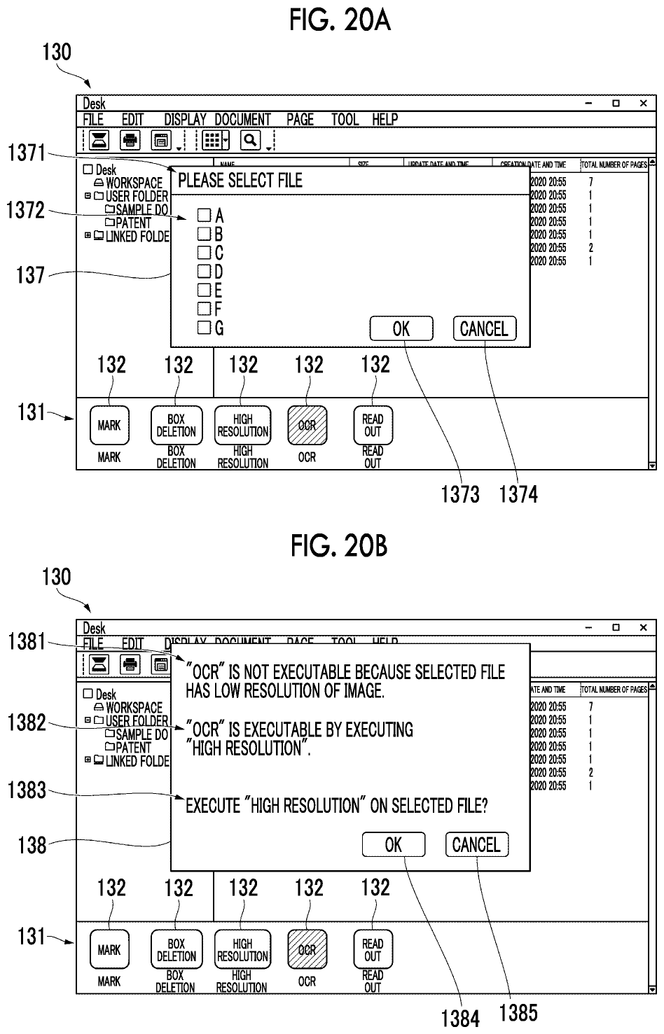

First, in a case where the plug-in icon 132 of “OCR” is selected by the user, a display color of the selected plug-in icon 132 changes as shown in FIG. 20A. In addition, a file selection screen 137 is displayed on the user terminal 20. The file selection screen 137 is a screen causing the user to select the file 50 of a target on which the process of the plug-in 30 shown by the selected plug-in icon 132 is executed. In other words, the file selection screen 137 is a screen causing the user to select the file 50 of a target on which the process of the requested plug-in is executed. A selection prompt portion 1371, a file list portion 1372, a decision portion 1373, and a cancelation portion 1374 are displayed on the file selection screen 137.

Information for prompting the user to select the file 50 is shown in the selection prompt portion 1371. In the shown example, a text “please select file” is shown in the selection prompt portion 1371.

A list of names of files 50 is shown in the file list portion 1372.

In a case where the decision portion 1373 is selected in a state where the file 50 is selected in the file list portion 1372, the file 50 selected in the file list portion 1372 is decided as the selected file.

In addition, in a case where the cancelation portion 1374 is selected, the file selection screen 137 is not displayed.

Here, for example, an assumption that the user selects the decision portion 1373 in a state where the file 50 consisting of the image document including an image of a resolution of 150 dpi is selected is made. In this case, the processor 11 determines that the process of the plug-in 30 of “OCR” is not executable for the selected file in the information output process based on “process target” of “OCR” in the information management table (refer to FIG. 12) (NO in S303 in FIG. 19). In addition, in this case, the processor 11 specifies the plug-in 30 of “high resolution” as the enabler plug-in (S305 in FIG. 19). Furthermore, as described above, the plug-in 30 of “high resolution” is downloaded to the user terminal 20 (YES in S306 in FIG. 19). In this case, an execution prompt screen 138 is displayed on the user terminal 20 as shown in FIG. 20B. The execution prompt screen 138 is a screen for prompting the user to execute the process of the enabler plug-in on the selected file. An unavailability notification portion 1381, a necessity notification portion 1382, a prompt portion 1383, a decision portion 1384, and a cancelation portion 1385 are displayed on the execution prompt screen 138.

Information indicating that execution of the process of the requested plug-in is not available for the selected file is shown in the unavailability notification portion 1381 as a reason that execution of the process is not available. In the shown example, a text ““OCR” is not executable because selected file has low resolution of image.” is shown in the unavailability notification portion 1381.

Information indicating the enabler plug-in 30 that needs to be executed on the selected file in order to execute the process of the requested plug-in on the selected file is shown in the necessity notification portion 1382. In the shown example, a text ““OCR” is executable by executing “high resolution”.” is shown in the necessity notification portion 1382. The necessity notification portion 1382 is an example of the information on the plug-in 30.

Information for prompting the user to execute the process of the enabler plug-in on the selected file is shown in the prompt portion 1383. In the shown example, a text “execute “high resolution” on selected file?” is shown.

In a case where the user selects the decision portion 1384, the processor 11 of the user terminal 20 executes the process of the enabler plug-in on the selected file 50. Thus, the decision portion 1384 is regarded as the execution reception information.

In addition, in a case where the user selects the cancelation portion 1385, the process of the enabler plug-in is not executed.

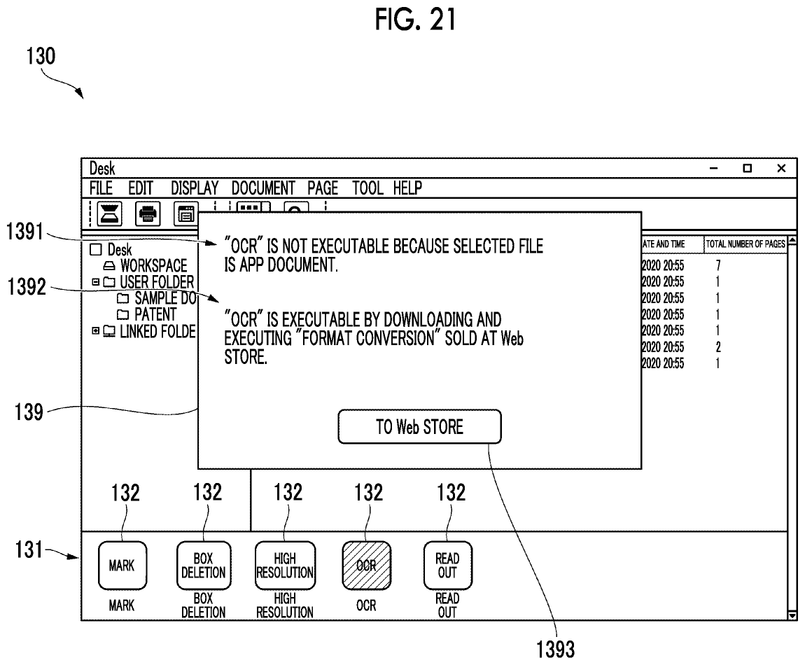

In addition, in a state shown in FIG. 20A, an assumption that the user selects the decision portion 1373 in a state where the file 50 consisting of the app document is selected is made. In this case, the processor 11 determines that the process of the plug-in 30 of “OCR” is not executable for the selected file in the information output process based on “process target” of “OCR” in the information management table (refer to FIG. 12) (NO in S303 in FIG. 19). In addition, in this case, the processor 11 specifies the plug-in 30 of “format conversion” as the enabler plug-in (S305 in FIG. 19). In addition, as described above, the plug-in 30 of “format conversion” is not downloaded to the user terminal 20 (NO in S306 in FIG. 19). In this case, a method notification screen 139 is displayed on the user terminal 20 as shown in FIG. 21. The method notification screen 139 is a screen for notifying the user of a method of downloading the enabler plug-in to the user terminal 20. An unavailability notification portion 1391, a necessity notification portion 1392, and a connection reception portion 1393 are displayed on the method notification screen 139.

Information indicating that execution of the process of the requested plug-in is not available for the selected file is shown in the unavailability notification portion 1391 as a reason that execution of the process is not available. In the shown example, a text ““OCR” is not executable because selected file is app document.” is shown in the unavailability notification portion 1391.

Information indicating the enabler plug-in 30 that needs to be executed on the selected file in order to execute the process of the requested plug-in on the selected file is shown in the necessity notification portion 1392. In addition, a method of downloading the enabler plug-in 30 is shown in the necessity notification portion 1392. In the shown example, a text ““OCR” is executable by downloading and executing “format conversion” sold at Web store.” is shown in the necessity notification portion 1392.

Any of the necessity notification portion 1382 shown on the execution prompt screen 138 in FIG. 20B and the necessity notification portion 1392 shown on the method notification screen 139 in FIG. 21 is an example of the information on the plug-in 30. In addition, in a broad sense, the execution prompt screen 138 and the method notification screen 139 are an example of the information on the plug-in 30.

In a case where the user selects the connection reception portion 1393, the processor 11 of the user terminal 20 causes the user terminal 20 to connect to the website for downloading the plug-in 30 of “format conversion”. Thus, the connection reception portion 1393 is regarded as the connection reception information.

In the present exemplary embodiment described above, while the processor 11 of the user terminal 20 displays the information on the enabler plug-in on the user terminal 20 in a case where the selected file and the requested plug-in are selected, the invention is not limited thereto.

In a case where the selected file and the requested plug-in are selected, and where the plug-in 30 having the relationship of the pre-process plug-in with the requested plug-in is present, the processor 11 may display the information on the pre-process plug-in on the user terminal 20. That is, the plug-in 30 that is a target of notification on the execution prompt screen 138 and the method notification screen 139 may be the pre-process plug-in.

Notification Example of Process Plug-In

Next, an example of notification of which plug-in 30 is the process plug-in among the plug-ins 30 stored in the user terminal 20 will be described.

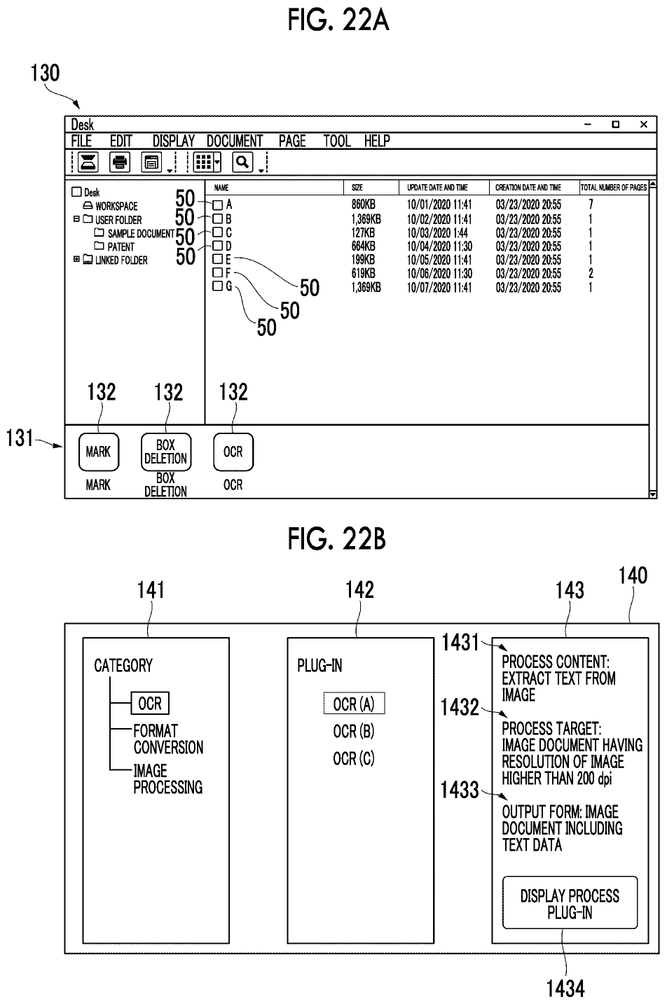

FIG. 22A is a diagram showing the management screen 130. The plug-in icon 132 of “mark”, the plug-in icon 132 of “box deletion”, and the plug-in icon 132 of “OCR” are shown in the toolbar 131 of the management screen 130 shown in FIG. 22A.

Here, for example, in a case where the user selects a display button (not shown) for displaying a content of the plug-in 30, a content notification screen 140 is displayed on the user terminal 20 as shown in FIG. 22B. The content notification screen 140 is a screen for notifying the user of the content of the plug-in 30. An item display portion 141, a plug-in display portion 142, and a content display portion 143 are displayed on the content notification screen 140.

Items divided by the content of the process executed by the plug-in 30 are shown in the item display portion 141. In the present exemplary embodiment, “OCR”, “format conversion”, and “image processing” are displayed as the items of the plug-in 30. In addition, in the shown example, “OCR” is selected in the item display portion 141.

A name of the plug-in 30 belonging to the item selected in the item display portion 141 is shown in the plug-in display portion 142. In the present exemplary embodiment, “OCR (A)”, “OCR (B)”, and “OCR (C)” are displayed in the plug-in display portion 142. In addition, in the shown example, “OCR (A)” is selected in the plug-in display portion 142. Hereinafter, the plug-in 30 selected in the plug-in display portion 142 will be referred to as a selected plug-in.

A content of the selected plug-in is shown in the content display portion 143. A content information portion 1431, a target information portion 1432, and an output information portion 1433 are displayed in the content display portion 143.

A content of a process executed by the selected plug-in is shown in the content information portion 1431. In the shown example, a text “process content: extract text from image” is shown in the content information portion 1431.

Information on a target for which the process of the selected plug-in is available is shown in the target information portion 1432. In the shown example, a text “process target: image document having resolution of image higher than 200 dpi” is shown in the target information portion 1432.

Information on a form of data output by executing the process of the selected plug-in is shown in the output information portion 1433. In the shown example, a text “image document including text data” is shown in the output information portion 1433.

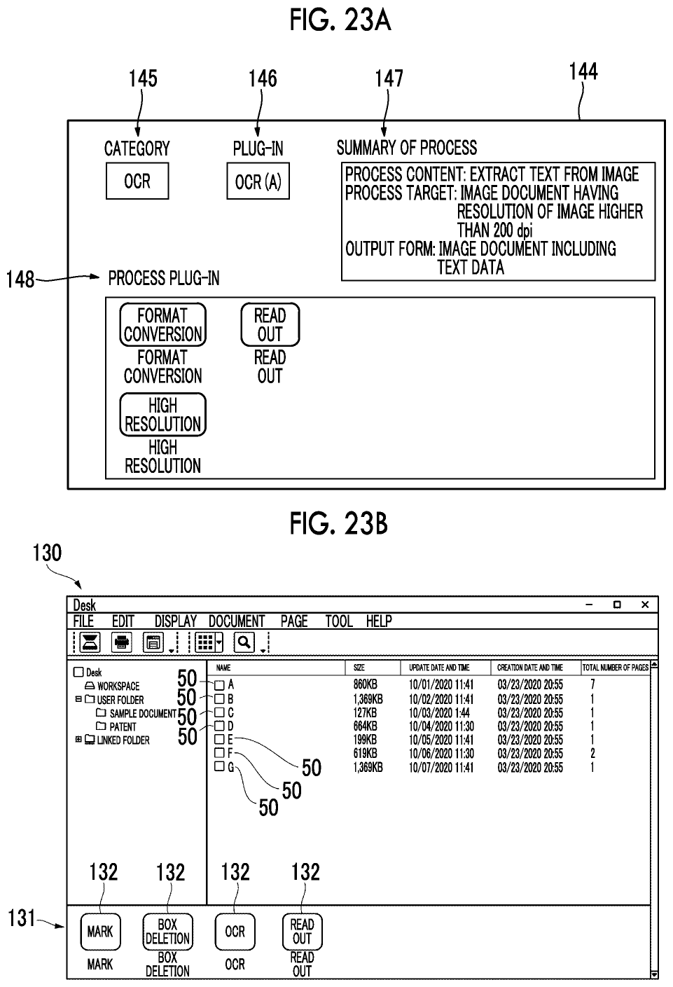

In addition, a process plug-in display button 1434 is displayed in the content display portion 143. In a case where the user selects the process plug-in display button 1434, a setting screen 144 is displayed on the user terminal 20 as shown in FIG. 23A. The setting screen 144 is a screen for causing the user to set the process plug-in to be displayed in the toolbar 131. An item information portion 145, a plug-in information portion 146, a selected content information portion 147, and a process plug-in display portion 148 are shown on the setting screen 144.

An item selected in the item display portion 141 of the content notification screen 140 (refer to FIG. 22B) is shown in the item information portion 145.

A name of the selected plug-in is shown in the plug-in information portion 146.

The content of the selected plug-in is shown in the selected content information portion 147. Information shown in the content information portion 1431 of the content display portion 143 (refer to FIG. 22B), information shown in the target information portion 1432, and information shown in the output information portion 1433 are displayed in the selected content information portion 147.

The icon of the plug-in 30 having a relationship of the process plug-in with the selected plug-in is shown in the process plug-in display portion 148. The icon of the plug-in 30 displayed in the process plug-in display portion 148 is an icon that is not displayed as the plug-in icon 132 in the toolbar 131. In the shown example, the icon of “format conversion”, the icon of “high resolution”, and the icon of “read out” are shown in the process plug-in display portion 148. Accordingly, information on the process plug-in is displayed in the process plug-in display portion 148 in a form associated with the selected plug-in. The process plug-in display portion 148 is an example of the information on the plug-in 30.

Here, for example, in a case where the user selects the icon of “read out”, the plug-in icon 132 of “read out” is newly displayed in the toolbar 131 of the management screen 130 as shown in FIG. 23B.

As described above, in the present exemplary embodiment, the processor 11 of the management server 10 or the like outputs the information on the second software in a case where a condition determined for a relationship between the first software and an operation performed by the user in the user terminal 20 to which the information on the first software is output is satisfied. For example, a case where the enabler plug-in reception portion 127 of the plug-in information portion 121 shown in FIG. 8 is selected by the user is exemplified as a case of satisfying the determined condition. In addition, for example, a case where any of the pre-process plug-in reception portion 1252 and the post-process plug-in reception portion 1254 of the plug-in information portion 121 shown in FIG. 14A is selected by the user is exemplified as a case of satisfying the determined condition. In addition, for example, a case where the download reception portion 124 in which a plurality of icons are shown is selected by the user in the plug-in information portion 121 shown in FIG. 15 is exemplified as a case of satisfying the determined condition. In addition, for example, a case where the pointer P is displayed in an overlapping manner with the display region of the plug-in icon 132 in accordance with the operation of the input device 16 performed by the user as shown in FIG. 18B is exemplified as a case of satisfying the determined condition. In addition, for example, a case where the process of the plug-in 30 is executed as shown in FIG. 18C, or a case where the decision portion 1373 is selected by the user in a state where the file 50 is selected on the file selection screen 137 shown in FIG. 20A is exemplified as a case of satisfying the determined condition. In addition, for example, a case where the process plug-in display button 1434 of the content notification screen 140 shown in FIG. 22B is selected by the user is exemplified as a case of satisfying the determined condition. In addition, for example, a case where an icon displayed in the process plug-in display portion 148 of the setting screen 144 shown in FIG. 23A is selected by the user is exemplified as a case of satisfying the determined condition.

In a case where the icon is selected in the process plug-in display portion 148, the plug-in icon 132 that is newly displayed in the toolbar 131 may be displayed inside the box image 133 (refer to FIG. 16) together with the plug-in icon 132 of the selected plug-in. In addition, the plug-in icon 132 newly displayed in the toolbar 131 may be included in the plural execution button 134 (refer to FIGS. 17A and 17B) together with the plug-in icon 132 of the selected plug-in. That is, the plug-in icon 132 newly displayed in the toolbar 131 may be displayed in a form associated with the plug-in icon 132 of the selected plug-in.

In the present exemplary embodiment, while the processor 11 of the management server 10 or the like displays the information on the first software and the information on the second software on the user terminal 20 using images, the invention is not limited thereto. The processor 11 of the management server 10 or the like may output the information on the first software and the information on the second software to the user terminal 20 by sound.

In addition, in the present exemplary embodiment, while the processor 11 of the management server 10 or the like outputs the information on the plug-in 30, a target for which information is output by the processor 11 may be application software and is not limited to the plug-in 30.

An example of outputting information on the application software different from the plug-in 30 by the processor 11 of the management server 10 or the like will be described. An assumption that application software of “specific process” and application software of “format conversion” are stored in the main memory 12 of the management server 10 or the like is made. Here, an assumption that data of a target of a process of the application software of “specific process” is a file in a hyper text markup language (HTML) format is made. In addition, an assumption that a process of the application software of “format conversion” is a process of converting a file in a portable document format (PDF) into a file in the hyper text markup language (HTML) format is made. In this case, the application software of “format conversion” is application software that executes a process to be performed before the process executed by the application software of “specific process”. More specifically, the process of the application software of “format conversion” is a process of changing a form of data for which the process of the application software of “specific process” is not available, to a form of data for which the process of the application software of “specific process” is available. In other words, the process of the application software of “format conversion” is a process that affects the process of the application software of “specific process”. In this case, the processor 11 of the management server 10 or the like may output information on the application software of “format conversion” in a form associated with information on the application software of “specific process”.

Another example of outputting the information on the application software different from the plug-in 30 by the processor 11 of the management server 10 or the like will be described. An assumption that the application software of “specific process” and application software of “size compression” are provided in the management server 10 or the user terminal 20 is made. Here, an assumption that data of a target of the process of the application software of “specific process” is a file having a smaller size than a predetermined value is made. In addition, for example, while the predetermined value may be any value, an assumption that the predetermined value is 100 MB is made. In addition, an assumption that a process of the application software of “size compression” is a process of compressing a file having a size of greater than or equal to 100 MB to a size of 1 MB is made. In this case, the application software of “size compression” is application software that executes a process to be performed before the process executed by the application software of “specific process”. More specifically, the process of the application software of “size compression” is a process of changing the form of the data for which the process of the application software of “specific process” is not available, to the form of the data for which the process of the application software of “specific process” is available. In other words, the process of the application software of “size compression” is a process that affects the process of the application software of “specific process”. In this case, the processor of the management server 10 or the like may output information on the application software of “size compression” in the form associated with the information on the application software of “specific process”.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

While the exemplary embodiment of the present invention is described above, the technical scope of the present invention is not limited to the scope disclosed in the exemplary embodiment. From the disclosure of the claims, each exemplary embodiment subjected to various changes or improvements apparently falls in the technical scope of the present invention.

In addition, while a plurality of exemplary embodiments are described above, a configuration included in one exemplary embodiment may be changed with a configuration included in another exemplary embodiment, or a configuration included in one exemplary embodiment may be added to another exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
output information on first software; and
output information on second software executing a process to be performed before or after a process executed by the first software, in a form associated with the information on the first software.

2. The information processing apparatus according to claim 1,
wherein the process of one software out of the first software or the second software is a process of changing a form of data for which the process of the other software is not available, to a form of data for which the process of the other software is available.

3. The information processing apparatus according to claim 1, wherein the processor is configured to:
output the information on the second software in a case where data for which the process of the first software is not available is determined.

4. The information processing apparatus according to claim 1, wherein the processor is configured to:
output information on different second software depending on a form of data determined as a target of the process of the first software.

5. The information processing apparatus according to claim 1, wherein the processor is configured to:
output results of the processes of the first software and the second software performed on data.

6. The information processing apparatus according to claim 5, wherein the processor is configured to:
output the results and a result of execution of the process of any one software out of the first software or the second software without executing the process of the other software.

7. A non-transitory computer readable medium storing a program causing a computer to implement:
a first output function of outputting information on first software; and
a second output function of outputting information on second software executing a process to be performed before or after a process executed by the first software, in a form associated with the information on the first software.

8. The non-transitory computer readable medium storing the program according to claim 7, the program causing the computer to further implement:
a function of displaying a specific reception image for receiving an instruction to execute a process of software from a user; and
a function of executing the processes of the first software and the second software in a case where the instruction is issued through the specific reception image.

9. The non-transitory computer readable medium storing the program according to claim 8,
wherein the information on the first software is a first reception image for receiving an instruction to execute the process of the first software from the user,
the information on the second software is a second reception image for receiving an instruction to execute the process of the second software from the user, and
a display region of the specific reception image is smaller than a combined region of a display region of the first reception image and a display region of the second reception image.

10. The non-transitory computer readable medium storing the program according to claim 7,
wherein the second output function is output of the information on the second software in a case where the process of the first software is executed.

11. The non-transitory computer readable medium storing the program according to claim 10,
wherein the second software is software stored in a memory of a terminal that is used by a user and in which the process of the first software is executed.

12. An information processing apparatus comprising:
means for outputting information on first software; and
means for outputting information on second software executing a process to be performed before or after a process executed by the first software, in a form associated with the information on the first software.
